(19) United States
(12) Patent Application Publication
(10) Pub. No.: US 2005/0184977 A1
(43) Pub. Date: Aug. 25, 2005

(54) Capacitive load drive circuit, method for driving the same, and plasma display apparatus

(75) Inventors: Katsumi Itoh, Kawasaki (JP); Tomokatsu Kishi, Kawasaki (JP); Shigetoshi Tomio, Kawasaki (JP); Tetsuya Sakamoto, Kawasaki (JP); Isao Furukawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 10/989,463

(22) Filed: Nov. 17, 2004

(30) Foreign Application Priority Data
Feb. 20, 2004 (JP) 2004-044598

(51) Int. Cl. G09G 5/00

(52) U.S. Cl. 345/204

(57) ABSTRACT

A capacitive load drive circuit that has reduced power consumption due to residual carriers, and a PDP apparatus using the same, have been disclosed. In the drive circuit, the power consumption due to the residual carriers, which are formed when a diode provided in parallel to a switch circuit of the capacitive load drive circuit is brought into conduction, is reduced and the switch circuit connected in parallel to the diode is brought into conduction during a period of time from when the diode is brought into conduction until when the potential of a terminal to which the diode is connected changes. By bringing the switch circuit connected in parallel into conduction, a closed circuit is formed by the diode and the switch circuit and the residual carriers formed in the diode are reduced. The voltage of the closed circuit is substantially zero V and, therefore, power consumption is very small even if a current due to the residual carriers flows through the closed circuit.

### BACKGROUND OF THE INVENTION

The present invention relates to a capacitive load drive circuit that changes the potential of each electrode of apparatuses such as a plasma display apparatus (a PDP apparatus) and a liquid crystal display apparatus, a method for driving the same, and a plasma display apparatus.

A plasma display apparatus (a PDP apparatus) or a liquid crystal apparatus comprises a plurality of electrodes arranged adjacently or in opposition to each other and the potential at each electrode is changed between a high potential and a low potential. Each electrode forms a capacitive load between itself and an electrode arranged adjacently thereto or between itself and an electrode arranged in opposition thereto, and a drive circuit for changing the potential at each electrode between the high potential and the low potential eventually changes the potential of a terminal of the capacitive load. Such a drive circuit is called a capacitive load drive circuit, is widely used and is not limited to use only in a PDP apparatus or a liquid crystal display apparatus. In a PDP apparatus, as the difference between a high potential and a low potential (the drive voltage) is large, it is necessary to use a drive element having a large withstand voltage and the period (the drive period) to be changed is also short, therefore, there arises a problem of such as heat radiation and more improvements to a capacitive load drive circuit are required. Here, although explanation is made using a capacitive load drive circuit used in a PDP apparatus as an example, the present invention is not limited to this capacitive load drive circuit but can be applied to other capacitive load drive circuits used in other apparatuses.

A PDP apparatus and a capacitive load drive circuit used therein are described, for example, in U.S. Pat. No. 6,686,912, U.S. Pat. No. 6,496,166 and U.S. Pat. No. 6,373,452, and are widely known, therefore, a detailed explanation will not be given here but only the points directly relating to the present invention are explained briefly.

In a PDP apparatus, a plurality of first electrodes (X electrodes) and second electrodes (Y electrodes) extending in a first direction are arranged by turns on one of substrates and a plurality of address electrodes extending in a second direction perpendicular to the first direction are arranged on the other opposing substrate, and a display cell is formed at the intersection between a pair of the neighboring X and Y electrodes and the address electrodes. A discharge gas is sealed in between the substrates, a voltage is applied across each gap between neighboring electrodes to cause a discharge to occur, and ultraviolet beams produced by the discharge excite phosphors provided on the opposing substrate to cause to emit light. A capacitor is formed between neighboring electrodes and, in particular, a large capacitor is formed between the X electrode and the Y electrode because the X and Y electrodes are arranged in parallel and adjacently.

A PDP apparatus currently put to practical use is an address/display separation system AC type PDP apparatus, in which a period during which a cell to be displayed is selected (an address period) and a display period during which a discharge is caused to occur for lighting to produce a display (a sustain period) are separated. FIG. 1 is a diagram showing drive waveforms in one subfield of an address/display separation system AC type PDP apparatus. As shown schematically, one subfield is made up of a reset period (R) during which all the display cells are put into a uniform state, an address period (A) during which display cells to be lit are selected, and a sustain period (S) during which a discharge is caused to occur repeatedly in the selected display cells to emit light. The luminance in each subfield is determined by the number of repeating discharges during the sustain period. As a PDP apparatus can take only two states, a lit state and an unlit state, a display field is made up of a plurality of subfields of different luminance and a display of gradation is produced by combining subfields to be lit for each cell.

The PDP apparatus comprises a first (X) electrode drive circuit, a second (Y) electrode drive circuit, and an address electrode drive circuit for changing the potentials of the X electrode, the Y electrode, and the address electrode, respectively, according to the drive waveforms shown in FIG. 1. The plurality of X electrodes are connected commonly and the X electrode drive circuit changes the potentials of all the X electrodes commonly. The Y electrode drive circuit applies a scan pulse sequentially to the Y electrodes during the address period and, at the same time, changes the potentials of all the Y electrodes commonly during the sustain period. The address electrode drive circuit applies an address pulse to the address electrodes in the display cells to be lit during the address period.

As shown schematically, during the sustain period, a sustain pulse is applied alternately to all the X electrodes and the Y electrodes and as the capacitance between the X electrode and the Y electrode is large. What consumes a large power among operations of the X electrode drive circuit and the Y electrode drive circuit is the application of the sustain pulse. The problem of the operation, that is, the application of the sustain pulse by the X electrode drive circuit and the Y electrode drive circuit is explained below.

FIG. 2A is a diagram showing a fundamental configuration of the X electrode drive circuit and the Y electrode drive circuit in the PDP apparatus, that is, a fundamental configuration of a capacitive load drive circuit. In FIG. 2A, Cp denotes a capacitor formed between the X electrode and the Y electrode, and the left-side part of the capacitor Cp corresponds to the X electrode drive circuit and the right-side part corresponds to the Y electrode drive circuit. As described above, the X electrodes are connected commonly and the X electrode drive circuit comprises, as shown schematically, a switch SW1 for switching connections between one terminal (the X electrode) of the capacitive load Cp and a high-potential side power supply, a switch SW2 for switching connections between the X electrode and a low-potential side power supply, a diode D1 provided in parallel to the switch SW1, and a diode D2 provided in parallel to the switch 2. The diodes D1 and D2 are provided in order to form a current path used when the potential of the Y electrode is changed and, at the same time, to change the potential of the X electrode during a period except for the sustain period shown in FIG. 1, which will be described later.

As described above, it is necessary for the Y electrode drive circuit to apply a scan pulse sequentially to the Y electrodes during the address period and the respective Y electrodes are provided with the individual second (Y) electrode drive circuits. Each of the individual Y electrode drive circuits comprises a switch SW3 for switching connections between the other terminal (the Y electrode) of the capacitive load Cp and a high-potential power supply, a switch SW4 for switching connections between the Y electrode and a low-potential power supply, a diode D3 provided in parallel to the switch SW3, and a diode D4 provided in parallel to the switch SW4. The diodes D3 and D4 are provided for the same purposes as the diodes D1 and D2. During the sustain period, all the individual Y electrode drive circuits perform the same action, therefore, it is assumed that the Y electrode drive circuit shown on the right-side in FIG. 2A corresponds to all the individual Y electrode drive circuits in the following explanation.

FIG. 2A shows a fundamental configuration of a capacitive load drive circuit when the respective potentials of the respective X electrode and the Y electrode, which form a capacitive load in a PDP apparatus, are changed, but there is another capacitive load drive circuit in which the potential of one terminal of a capacitive load is fixed and only the potential of the other terminal is changed. In such a case, the capacitive load drive circuit has a fundamental configuration as shown in FIG. 2B. The present invention can also be applied to the fundamental configuration shown in FIG. 2B.

FIG. 3A to FIG. 3C are diagrams showing examples of switch elements used as the switches SW1 to SW4. In the PDP apparatus, a voltage of about 180V is applied between the X electrode and the Y electrode, therefore, it is necessary to use elements having a high withstand voltage. FIG. 3A show a bipolar transistor, FIG. 3B shows a MOSFET, and FIG. 3C shows an IGBT. In the MOSFET, a parasitic diode is formed in parallel thereto. Therefore, if the MOSFET is used as the switches SW1 to SW4 shown in FIG. 2A and FIG. 2B, the diodes D1 to D4 are formed as a result, and there may be a case where only the diodes D1 to D4 formed as described above are used, or a case where another diode is further provided additionally. In either case, such parasitic diodes are also used as the diodes D1 to D4. There is a case where the bipolar transistor and IGBT have no parasitic diode, therefore, when the switches SW1 to SW4 are made up of the bipolar transistor and IGBT, another diode is further provided additionally.

The MOSFET allows a current to flow in both the directions but the bipolar transistor and the IGBT allow a current to flow only in one direction. Moreover, after the bipolar transistor and IGBT are brought into the ON-state to allow a current to flow, there exist a number of residual carriers in the elements and the state will be maintained for a somewhat long time. In contrast to this, after the MOSFET is brought into the ON-state to allow a current to flow, the residual carriers decrease rapidly. However, if a current flows through the parasitic diode of the MOSFET, there exist a number of residual carriers and the state is maintained for a somewhat long time. Similarly, if a current flows through the individual diodes, there exist a number of residual carriers in the elements and the state is maintained for a somewhat long time.

FIG. 4 is a diagram showing switch timings and changes in the potential of the capacitive load in the capacitive load drive circuit shown in FIG. 2A, and FIG. 5A to FIG. 5D are diagrams for explaining the current path in each case. In each figure, an arrow indicates a current path and a broken line arrow indicates a current due to the residual carriers. Each figure shows an example of a drive method in which the potentials of the X electrode and the Y electrode become the low potential (L) simultaneously, but do not become the high potential (H) simultaneously. When the potential of the X electrode is changed from the low potential to the high potential, SW2 and SW3 are brought into the OFF-state (the cutoff state) and while SW4 is maintained in the ON-state (the conduction state), SW is brought into the ON-state. Due to this, as shown in FIG. 5A, the X electrode of Cp is connected to the high-potential power supply of the X electrode drive circuit via SW1 and the X electrode changes from the low potential to the high potential. A current path needs to be formed in order for Cp to perform such a discharge and in this case, a current path from the high-potential power supply to the low-potential power supply of the Y electrode drive circuit via SW1, Cp and SW4 is formed. After the X electrode changes to the high potential, SW1 and SW4 are brought into the OFF-state.

When the potential of the X electrode is changed from the high potential to the low potential, SW1, SW3 and SW4 are brought into the OFF-state (the cutoff state) and SW2 is brought into the ON-state. Due to this, the X electrode of Cp is connected to the low-potential power supply in the X electrode drive circuit via SW2 and the X electrode changes from the high potential to the low potential. In this case, a current path is formed as follows: the low-potential power supply in the Y electrode drive circuit, D4, Cp, SW2 and to the low-potential power supply in the X electrode drive circuit. In FIG. 4, D4 denotes a current flowing through the diode D4. In this manner, D4 is used to form a current path. If SW4 is made up of a bipolar transistor or an IGBT, it is not possible to make a current flow in the direction of the path, therefore, D4 is absolutely indispensable. Moreover, if SW4 is made up of a MOSFET, it is possible to make a current flow in the direction of the path, but D4 exists because a parasitic diode exists in the MOSFET.

When the potential of the Y electrode is changed from the low potential to the high potential, SW1 and SW4 are brought into the OFF-state and, while SW2 is maintained in the ON-state, SW3 is brought into the ON-state. Due to this, the X electrode of Cp is connected to the high-potential power supply in the Y electrode drive circuit via SW3 as shown in FIG. 5C and the Y electrode changes from the low potential to the high potential. In this case, a current path is formed as follows: the high-potential power supply in the Y electrode drive circuit, SW3, Cp, SW2 and to the low-potential power supply in the X electrode drive circuit. After the X electrode changes to the high potential, SW2 and SW3 are brought into the OFF-state.

When the potential of the Y electrode is changed from the high potential to the low potential, SW1, SW2 and SW3 are brought into the ON-state and SW4 is brought into the ON-state. Due to this, as shown in FIG. 5D, the X electrode of Cp is connected to the low-potential power supply in the Y electrode drive circuit via SW4 and the Y electrode changes from the high potential to the low potential. In this case, a current path is formed as follows: the low-potential power supply in the X electrode drive circuit, D2, Cp, SW4 and to the low-potential power supply in the Y electrode drive circuit. In FIG. 4, D2 denotes a current flowing through the diode D2. As described above, it is necessary for D2 to exist.

FIG. 4 and FIG. 5A to FIG. 5D show an example of a drive method in which the potentials of the X electrode and the Y electrode become the low potential simultaneously but do not become the high potential simultaneously in the capacitive load drive circuit shown in FIG. 2A, but there is a drive method in which the potentials of the X electrode and the Y electrode become the high potential simultaneously but do not become the low potential simultaneously. FIG. 6 is a diagram showing switch timings and changes in potential of a capacitive load in the case of the drive method in which the potentials of the X electrode and the Y electrode become the high potential simultaneously but do not become the low potential simultaneously, and FIG. 7A to FIG. 7D are diagrams for explaining current paths in those cases, corresponding to FIG. 5A to FIG. 5D, respectively.

As the operations in FIG. 6 and FIG. 7A to FIG. 7D are similar to those shown in FIG. 4 and FIG. 5A to FIG. 5D, no explanation will be given here, but it should be noted that D1 and D3 are used for forming the current paths in the operations shown in FIG. 6 and FIG. 7A to FIG. 7D.

As described above, in the operations shown in FIG. 4 and FIG. 5A to FIG. 5D, D2 and D4 are used for forming the current paths but D1 and D3 are not used, and in the operations shown in FIG. 6 and FIG. 7A to FIG. 7D, D1 and D3 are used for forming the current paths but D2 and D4 are not used. As described above, however, D1 to D4 are used to change the potentials of the X electrode and the Y electrode during the reset period and address period and are provided in the X electrode and Y electrode drive circuits in an actual PDP apparatus, therefore, an example case where D1 to D4 are provided is explained here, but the scope of the invention is not limited to this case.

### SUMMARY OF THE INVENTION

As described above, after the bipolar transistor and IGBT are brought into the ON-state to allow a current to flow, there exist a number of residual carriers in the elements and the state is maintained for a somewhat long time. Moreover, when a current flows through the parasitic diode and the individual diodes of the MOSFET, there exist a number of residual carriers in the elements and the state is maintained for a somewhat long time.

In the PDP apparatus, the number of sustain pulses relates to the luminance of a display and there is a demand for an increase in number of sustain pulses in one display frame for improving luminance. Therefore, the period of a sustain pulse is required to be as short as possible and, for example, a period of about 1 μs is desired. If, however, the period of a sustain pulse is shortened, there arises a problem in that, before the residual carriers, which are produced when the bipolar transistor and IGBT are brought into conduction, decrease, the potentials of the terminals (X electrode and Y electrode) of a capacitive load change, and the residual carriers act as a load. This problem is explained below with reference to FIG. 5A to FIG. 5D. An explanation is given on the assumption that all switches are made of IGBT and an individual diode is connected in parallel to each IGBT.

As shown in FIG. 5A, when the potential at the X electrode changes from the low potential to the high potential, SW1 and SW4 are brought into conduction and, therefore, residual carriers are formed in SW1 and SW4. As shown in FIG. 5B, when the potential at the X electrode changes from the high potential to the low potential, SW2 and D4 are brought into conduction and charges stored in Cp flow as a current from the X electrode to the low-potential power supply in the X electrode drive circuit. At this time, the residual carriers in SW1 also flow via SW2. Therefore, a current corresponding to the sum of the charges stored in Cp and the residual carriers in SW1 flows to the low-potential power supply in the X electrode drive circuit via SW2. Moreover, as D4 is brought into conduction, the residual carriers are formed in D4.

Similarly, as shown in FIG. 5C, when the potential at the Y electrode changes from the low potential to the high potential, a current corresponding to the sum of the charges that charge the Y electrode of Cp and the residual carriers in D4 flows via SW3. The residual carriers when SW4 is brought into conduction will decrease readily because a longer time has elapsed since the formation thereof than that of the residual carriers formed in D4, but when the residual carriers are left, a current corresponding to the residual carriers in SW4 is added to the current flowing via SW3. Similarly, in the case of FIG. 5D, a current corresponding to the residual carriers in SW3 is added to the current flowing through SW4, and in the case of FIG. 5A, a current corresponding to the residual carriers in D2 and SW2 is added to the current flowing through SW1.

In the operations shown in FIG. 7A to FIG. 7D also, a current to which a current corresponding to the residual carriers has been added flows.

Power P consumed by the residual carriers in the capacitive load drive circuit described above is expressed as
P=Qc×Vs×f
where a charge amount of residual carriers that increase a drive current is Qc, a potential difference (voltage) between the high potential and the low potential is Vs, and a sustain frequency is f.

As described above, in the PDP apparatus, a voltage to be applied to a capacitive load (between the X electrode and the Y electrode) is as high as about 180V and the sustain frequency f is also high, therefore, there arises a big problem of an increase in power consumption by the residual carriers that increase the drive current and of heat generation in drive elements in conjunction therewith.

The object of the present invention is to reduce power consumption by residual carriers in a capacitive load drive circuit and a PDP apparatus using the same.

In order to attain the above-mentioned object, according to the present invention, the residual carriers are reduced by driving the carriers using a voltage sufficiently lower than the drive voltage instead of using the drive voltage to be applied to the capacitive load (between the X electrode and the Y electrode). As the voltage to be used to reduce the residual carriers is small, the power consumption can be considerably reduced compared to the case where the residual carriers are reduced using the drive voltage.

In a first aspect according to the present invention, power consumption by residual carriers, which are formed when a diode provided in parallel to a switch circuit of a capacitive load drive circuit is brought into conduction, is reduced, and the switch circuit connected in parallel to the diode is brought into conduction (brought into the ON-state) during a period of time from when the diode is brought into conduction until the potential of a terminal to which the diode is connected changes. By bringing the switch circuit connected in parallel to the diode into conduction, a closed circuit is formed by the diode and the switch circuit and the residual carriers formed in the diode are reduced. The voltage applied to the closed circuit is almost zero and power consumption is very small even if a current due to the residual carriers flows through the closed circuit.

The first aspect according to the present invention can also be applied to a case where a capacitive load drive circuit having the fundamental configurations shown in FIG. 2A and FIG. 2B is driven and can be further applied to the first (X) electrode drive circuit and the second (Y) electrode drive circuit in the PDP apparatus.

A second aspect according to the present invention comprises an inductance element at the output part of a capacitive load drive circuit. When a discharge (charge) of a capacitive load is completed and the current that flows through the diode is terminated, a voltage in the opposite direction is generated by the counter electromotive force of the inductance element and a current flows in the direction in which the residual carriers formed in the diode are reduced. The inductance value of the inductance element is set to the minimum value that can reduce the residual carriers formed in the diode.

The second aspect according to the present invention can be applied not only to a capacitive load drive circuit having the fundamental configurations shown in FIG. 2A and FIG. 2B but also to the first (X) electrode drive circuit and the second (Y) electrode drive circuit in the PDP apparatus. By the way, if the inductance element is provided in one of the left and right drive circuits, the residual carriers formed in the diode in the other drive circuit can be reduced. When a current flows through the diode in the other drive circuit, a current flows through the inductance element in the one of the drive circuits via the capacitive load, therefore, when the current is terminated, a voltage due to the counter electromotive force is generated across the inductance element and the residual carriers in the diode in the other drive circuit are reduced via the capacitive load.

A third aspect according to the present invention comprises a voltage source that generates a potential higher than the low potential and lower than the high potential and an intermediate offset switch that switches connections between the terminal of the capacitive load and the voltage source, and when the terminal of the capacitive load is at the low potential, the intermediate off switch is brought into conduction by temporarily putting it into the ON-state. Due to this, the residual carriers in the switch circuit and the diode connected between the terminal of the capacitive load and the low-potential power supply are reduced. This causes the potential of the terminal of the capacitive load to vary by the amount of voltage corresponding to the power supply, but if the voltage of the voltage source is small, no problem will be brought about. For example, when the drive voltage is 180V and the voltage of the voltage source is 5V, the power consumption by the residual carriers can be reduced to 1/36.

The third aspect can be applied to a capacitive load drive circuit having the fundamental configuration shown in FIG. 2A and FIG. 2B, and can also be applied to the first (X) electrode drive circuit and the second (Y) electrode drive circuit in the PDP apparatus. If the voltage source that generates a voltage higher than the low potential and lower than the high potential and the intermediate offset switch that switches connections between the terminal of the capacitive load and the voltage source are provided in one of the left and right drive circuits, the residual carriers formed in the diode in the other drive circuit can be reduced. When the terminal of the other side of the capacitive load is at the low potential, and if the intermediate offset switch is put into the ON-state, a current flows through the switch circuit or diode connected to the low potential power supply at the other side via the capacitive load and the residual carriers are reduced.

A fourth aspect according to the present invention comprises a high power supply switch that switches connections between the high potential side terminal of a first switch and the high potential side power supply, a voltage source that generates a voltage higher than the high potential by a predetermined value, and a high potential offset switch that switches connections between the high potential side terminal of the first switch and the voltage source, and when the terminal of the capacitive load is at the high potential, the high potential offset switch is brought into conduction by temporarily putting it into the ON-state. Due to the residual carriers in the switch circuit and the diode connected between the capacitive load terminal, the high potential power supply can be reduced. This causes the potential of the capacitive load terminal to vary by the amount of voltage corresponding to the power supply, but if the voltage of the voltage source is small, no problem will be brought about. For example, when the drive voltage is 180V and the voltage of the voltage source is 5V, the power consumption by the residual carriers can be reduced to 1/36.

The fourth aspect can be applied to a capacitive load drive circuit having the fundamental configuration shown in FIG. 2A and FIG. 2B and can also be applied to the first (X) electrode drive circuit and the second (Y) electrode drive circuit in the PDP apparatus. In order to reduce the residual carriers in the switch circuit and diode connected between the capacitive load terminal and the high potential power supply in both the left and right drive circuits in the fundamental configuration shown in FIG. 2A, it is necessary to provide a high power supply switch, a voltage source that generates a potential higher than the high potential by a predetermined value, and a high potential offset switch in both the drive circuits.

A fifth aspect according to the present invention is applied to an ALIS system PDP apparatus disclosed in U.S. Pat. No. 6,373,452. In the ALIS system PDP apparatus, first electrodes (X electrodes) and second electrodes (Y electrodes) are arranged adjacently by turns, a first display line is formed between the Y electrode and the X electrode adjacent to one side of the Y electrode in question, and a second display line is formed between the Y electrode and the X electrode adjacent to the other side of the Y electrode and, in an odd field in which a display is produced by the use of the first display lines, in-phase sustain pulses are applied to odd-numbered X electrodes and even-numbered Y electrodes and are also applied to even-numbered X electrodes and odd-numbered Y electrodes during the sustain period and, in an even field in which a display is produced by the use of the second display lines, in-phase sustain pulses are applied to odd-numbered X electrodes and odd-numbered Y electrodes and are also applied to even-numbered X electrodes and even-numbered Y electrodes during the sustain period. Moreover, the respective X and Y electrodes form the same respective capacitive loads between themselves and the respective neighboring electrodes on both the sides thereof. The drive circuit is provided with an odd X electrode drive circuit that drives odd-numbered X electrodes, an even X electrode drive circuit that drives even-numbered X electrodes, an odd Y electrode drive circuit that drives odd-numbered Y electrodes, and an even Y electrode drive circuit that drives even-numbered Y electrodes.

According to the fifth aspect of the present invention, during the sustain period in the odd field, the even Y electrode drive circuit supplies a sustain pulse delayed by a brief period of time from that in the odd X electrode drive circuit and the odd Y electrode drive circuit supplies a sustain pulse delayed by a brief period of time from that in the even X electrode drive circuit, and during the sustain period in the even field, the odd Y electrode drive circuit supplies a sustain pulse delayed by a brief period of time from that in the odd X electrode drive circuit and the even Y electrode drive circuit supplies a sustain pulse delayed by a brief period of time from that in the even X electrode drive circuit. Here, a “brief period of time” means a time sufficiently shorter than a time required for the change of potential when the potential of the X electrode or Y electrode is changed by switching switches.

A conventional ALIS system PDP apparatus comprises X electrodes and Y electrodes to which in-phase sustain pulses are applied. Those electrodes are referred to as in-phase X electrodes and in-phase Y electrodes, respectively, here. According to the fifth aspect of the present invention, a sustain pulse to be applied to the in-phase Y electrode is delayed from a sustain pulse to be applied to the in-phase X electrode by a very brief period of time. Due to this, the potential of the in-phase X electrode changes slightly before the change of the potential of the in-phase Y electrode and this change propagates to the Y electrode via a capacitor between the in-phase X and Y electrodes, reducing the residual carriers in the switches that make up the Y electrode drive circuit. As the amount of delay is small, the potential difference (voltage) between the in-phase X and Y electrodes produced when the potentials of both the electrodes change is small, and the residual carriers are driven by this voltage, therefore, the power consumption by the residual carriers can be considerably reduced.

In the conventional ALIS system PDP apparatus, in-phase sustain pulses are applied to the in-phase X and Y electrodes, therefore, the capacitor between the in-phase X and Y electrodes does not act as a load to the drive circuit. In contrast to this, according to the fifth aspect of the present invention, as a potential difference is produced between the in-phase X and Y electrodes, the capacitor will act as a load to the drive circuit but, if the potential difference between the in-phase X and Y electrodes is small, the effect of reduction in power consumed by the residual carriers is stronger than the effect of increase in drive power due to the load.

It is also possible to reduce the power consumption by the residual carriers as follows. During the sustain period in the odd field, the even Y electrode drive circuit supplies a sustain pulse whose sustain pulse fall is slightly delayed from that in the odd X electrode drive circuit and the odd Y electrode drive circuit supplies a sustain pulse whose sustain pulse fall is slightly delayed from that in the even Y electrode drive circuit, and during the sustain period in the even field, the odd Y electrode drive circuit supplies a sustain pulse whose sustain pulse fall is slightly delayed from that in the odd X electrode drive circuit and the even Y electrode drive circuit supplies a sustain pulse whose sustain pulse fall is slightly delayed from that in the even X electrode drive circuit.

What can be reduced in the fifth aspect is only the power consumption by the residual carriers formed in the elements that make up the switch circuit of the Y electrode drive circuit, and the power consumption by the residual carriers in the elements that make up the switch circuit of the X electrode drive circuit cannot be reduced. Therefore, when the switch circuits of the X and Y electrode drive circuits are composed of bipolar transistors or IGBTs, the power consumption by the residual carriers can be halved at most.

It is necessary for the Y electrode drive circuit to integrate the individual Y electrode drive circuits, the number of which is equal to that of the Y electrodes. If the individual Y electrode drive circuit is composed of IGBTs, the residual carriers cause a problem. If the fifth aspect is applied here, the power consumption by the residual carriers formed in the IGBTs that make up the switch circuit of the Y electrode drive circuit can be halved and the power consumption can be reduced because the number of the residual carriers in the MOSFETs that make up the X electrode drive circuit is small.

When the switch circuits of the odd and even X electrode drive circuits are composed of MOSFETs, the parasitic diode that exists in parallel with a MOSFET can be used or another individual diode can be connected thereto.

### BRIEF DESCRIPTION OF THE DRAWINGS

The features and advantages of the invention will be more clearly understood from the following description taken in conjunction with the accompanying drawings, in which:

FIG. 1 is a diagram showing examples of drive waveforms in a PDP apparatus.

FIG. 2A and FIG. 2B are diagrams showing fundamental configurations of a capacitive load drive circuit.

FIG. 3A to FIG. 3C are diagrams showing examples of switch elements.

FIG. 4 is a diagram showing switch timings and changes in the potential of capacitive loads in a conventional example.

FIG. 5A to FIG. 5D are diagrams for explaining a current path during discharge and charge of a capacitive load.

FIG. 6 is a diagram showing another conventional example of switch timings and changes in the potential of capacitive loads.

FIG. 7A to FIG. 7D are diagrams for explaining a current path during discharge and charge of a capacitive load in another conventional example.

FIG. 8 is a diagram showing a general configuration of a PDP apparatus in a first embodiment of the present invention.

FIG. 9 is a diagram showing switch timings and changes in the potential of electrodes in the first embodiment.

FIG. 10A to FIG. 10C are diagrams for explaining operations in the first embodiment.

FIG. 11 is a diagram showing switch timings and changes in the potential of electrode in a second embodiment.

FIG. 12A and FIG. 12B are diagrams showing configurations of a drive circuit in a third embodiment of the present invention.

FIG. 13A and FIG. 13B are diagrams showing other operations in the third embodiment.

FIG. 14A and FIG. 14B are diagrams showing configurations of a drive circuit in a fourth embodiment of the present invention.

FIG. 15 is a diagram showing switch timings and changes in the potential of electrodes in the fourth embodiment.

FIG. 16A and FIG. 16B are diagrams showing configurations of a drive circuit in a fifth embodiment of the present invention.

FIG. 17 is a diagram showing switch timings and changes in the potential of electrodes in the fifth embodiment.

FIG. 18 is a diagram showing a modification example of configuration in the fifth embodiment.

FIG. 19 is a diagram showing a general configuration of an ALIS system PDP apparatus in a sixth embodiment of the present invention.

FIG. 20 is a diagram showing a configuration of a drive circuit in the sixth embodiment.

FIG. 21 is a diagram showing waveforms in an odd field in a PDP apparatus in the sixth embodiment.

FIG. 22 is a diagram showing switch timings and changes in the potential of electrodes in the odd field in the sixth embodiment.

FIG. 23 is a diagram showing details of switch timings and changes in the potential of electrodes in the sixth embodiment.

FIG. 24 is a diagram for explaining current paths in the sixth embodiment.

FIG. 25 is a diagram showing drive waveforms in an even field in the PDP apparatus in the sixth embodiment.

FIG. 26 is a diagram showing switch timings and changes in the potential of electrodes in the even field in the sixth embodiment.

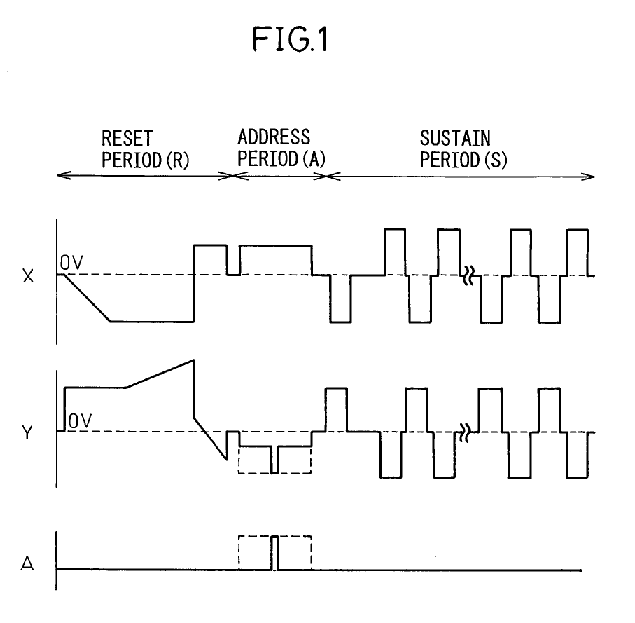

### DESCRIPTION OF THE PREFERRED EMBODIMENTS

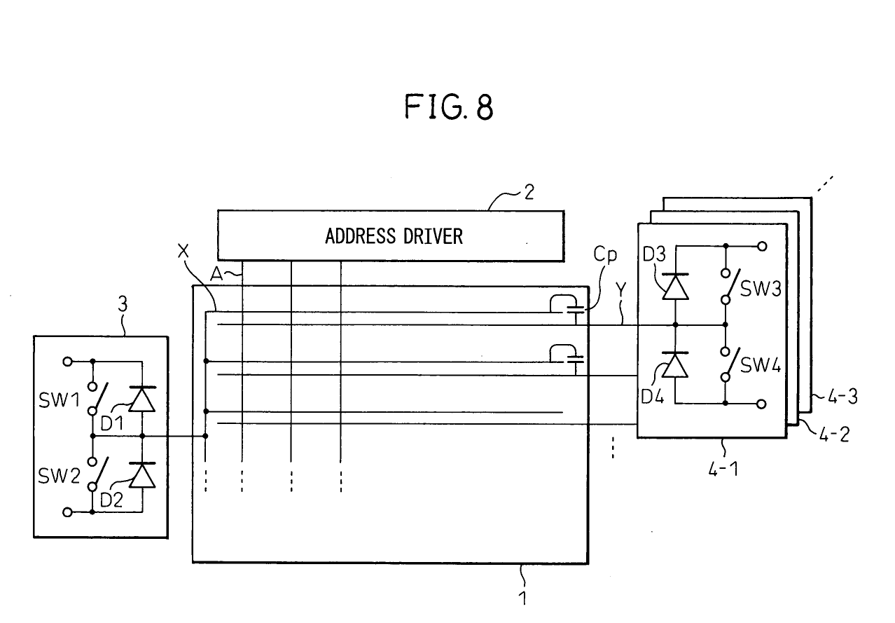

FIG. 8 is a diagram showing a general configuration of a PDP apparatus in a first embodiment of the present invention. As shown in FIG. 8, on a plasma display apparatus 1, a plurality of X electrodes and a plurality of Y electrodes are arranged adjacently by turns and a plurality of address electrodes A are arranged so as to be perpendicular to the X electrodes and the Y electrodes. A display cell is formed at the intersection of a pair of the X electrode and the Y electrode adjacent to each other and the address electrode. A capacitive load Cp is formed between a pair of the X electrode and the Y electrode adjacent to each other.

The plurality of the address electrodes A are driven individually by an address driver 2. One end of each of the plurality of the X electrodes is connected commonly and driven commonly by an X electrode drive circuit 3. A Y electrode drive circuit is composed of individual Y electrode drive circuits 4-1, 4-2, . . . , the number of which is equal to that of the Y electrodes, and each of the individual Y electrode drive circuits drives the Y electrode corresponding thereto.

The configuration described above is the same as that of a conventional PDP apparatus and the details thereof are described in, for example, U.S. Pat. No. 6,686,912, U.S. Pat. No. 6,496,166 and U.S. Pat. No. 6,373,452. Therefore, an explanation will not be given here.

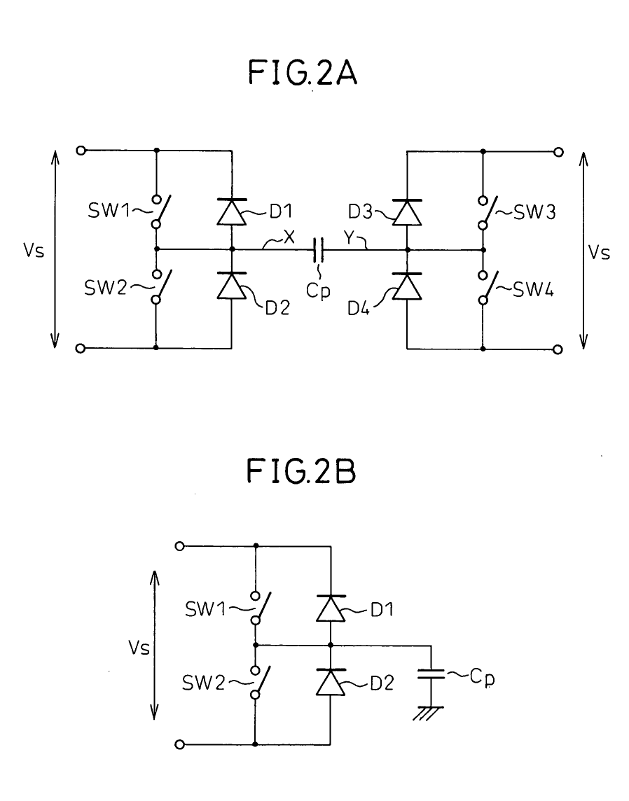

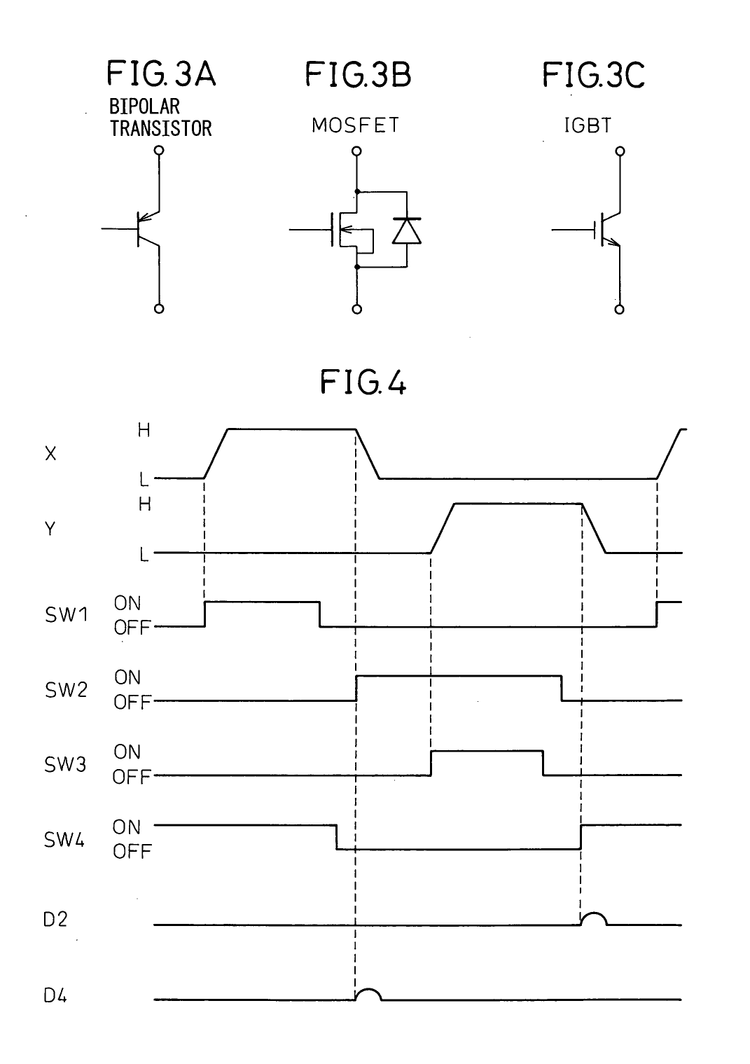

As shown in FIG. 8, the X electrode drive circuit 3 and each of the individual Y electrode drive circuits 4-1, 4-2, . . . , have the same configuration as that of the capacitive load drive circuit shown in FIG. 2A. During the sustain period, the plurality of the individual Y electrode drive circuits 4-1, 4-2, . . . , perform the same operation, therefore, the plurality of the individual Y electrode drive circuits 4-1, 4-2, . . . , are together referred to as a Y electrode drive circuit 4 and it is assumed that the Y electrode drive circuit 4 has the configuration as shown in FIG. 2A.

In the PDP apparatus in the first embodiment, it is assumed that switches SW1 and SW2 in the X electrode drive circuit 3 are composed of a MOSFET and diodes D1 and D2 are composed of a parasitic diode of the MOSFETs making up SW1 and SW2 and an individual diode connected in parallel to the MOSFET. Switches SW3 and SW4 in each of the individual Y electrode drive circuits 4-1, 4-2, . . . , are composed of an IGBT, diodes D3 and D4 are composed of an individual diode connected in parallel to the IGBT making up SW3 and SW4, and the plurality of the individual Y electrode drive circuits 4-1, 4-2, . . . , are integrated into an IC chip. The reason to configure in the manner described above is that the IGBT is more suitable for integration compared to the MOSFET.

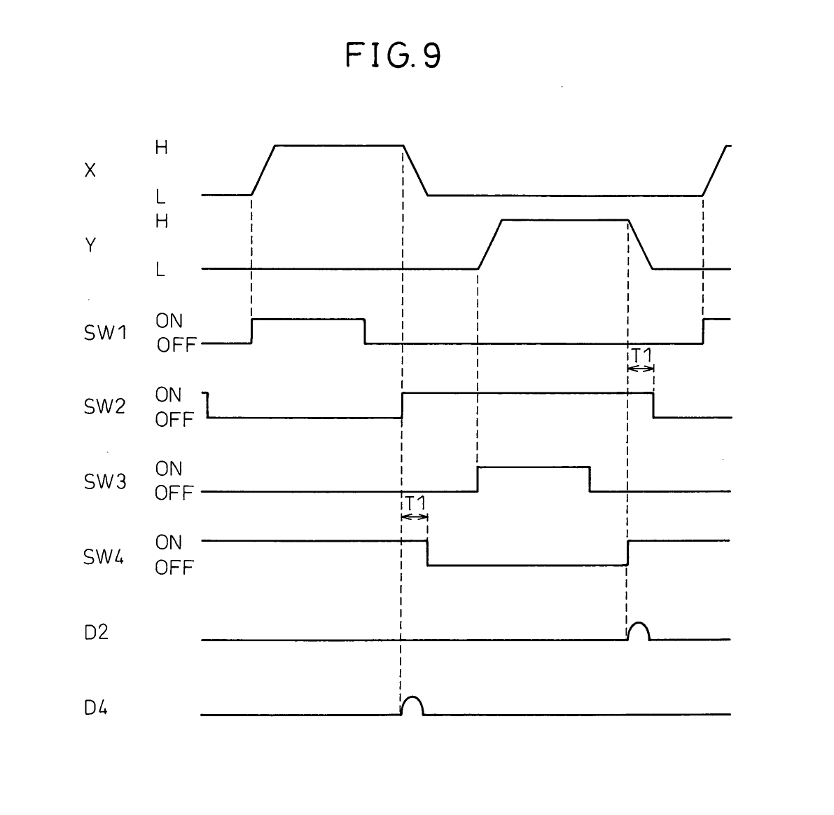

FIG. 9, which corresponds to FIG. 4, is a diagram showing switch timing of each switch circuit in the X electrode drive circuit 3 and the Y electrode drive circuit 4, changes in the potential of the X and Y electrodes, and currents that flow through the diodes D2 and D4 during the sustain period of the PDP apparatus in the first embodiment. By the way, D1 and D3 are provided to change the potential of the X and Y electrodes during the reset period and the address period although they are not used during the sustain period in the first embodiment.

As is obvious from comparison between FIG. 9 and FIG. 4, the first embodiment differs from the conventional case in that a period of time during which SW2 is in the ON-state (in the conduction state) is extended until when T1 elapses after SW4 is put into the ON state and that a period of time during which SW4 is in the ON-state (in the conduction state) is extended until when T1 elapses after SW2 is put into the ON state. T1 is a period of time during which SW2 or SW4 is put into the ON-state and a current flows through D4 or D2.

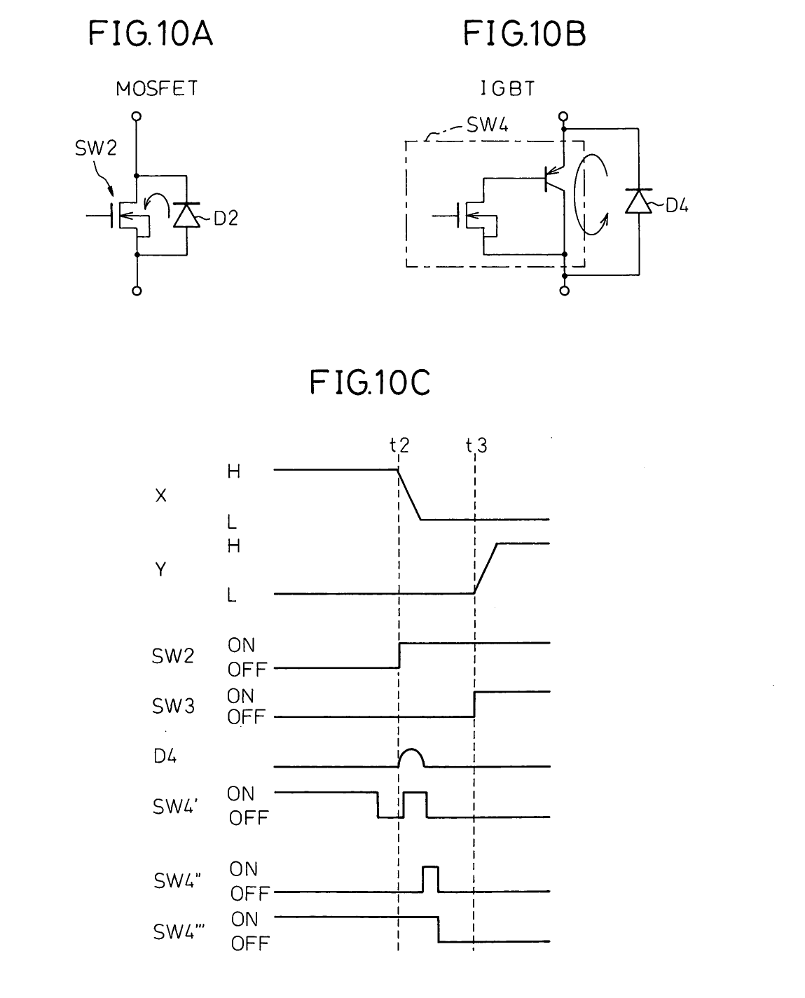

FIG. 10A to FIG. 10C are diagrams for explaining operations resulting from the extension of the period of time during which SW2 and SW4 are in the ON-state. As described in FIG. 4B, when the potential at the X electrode is changed from H to L, SW2 is put into the ON-state and the potential of the X electrode is changed to L by forming a current path from the low potential power supply of the Y electrode drive circuit to the low potential power supply of the X electrode drive circuit via D4, Cp, and SW2. As D4 is put into the ON-state and a current flows, residual carriers are formed in D4 when the potential of the X electrode changes to L and the current is terminated. The residual carriers in D4 increase the power consumption when the potential at the Y electrode is changed from L to H subsequently. In the first embodiment, therefore, by extending the period of time during which SW4 is in the ON-state until when the current flowing through D4 is terminated, a closed circuit (a loop) composed of SW4 and D4 is formed as shown in FIG. 10B, and thereby the residual carriers in D4 are reduced. Similarly, by extending the period of time during which SW2 is in the ON-state until when the current flowing through D2 is terminated, a closed circuit (a loop) composed of SW2 and D2 as shown in FIG. 10A is formed, and thereby the residual carriers in D2 are reduced. As the drive voltage of the closed circuit is very small, power consumption when the residual carriers are reduced is also very small.

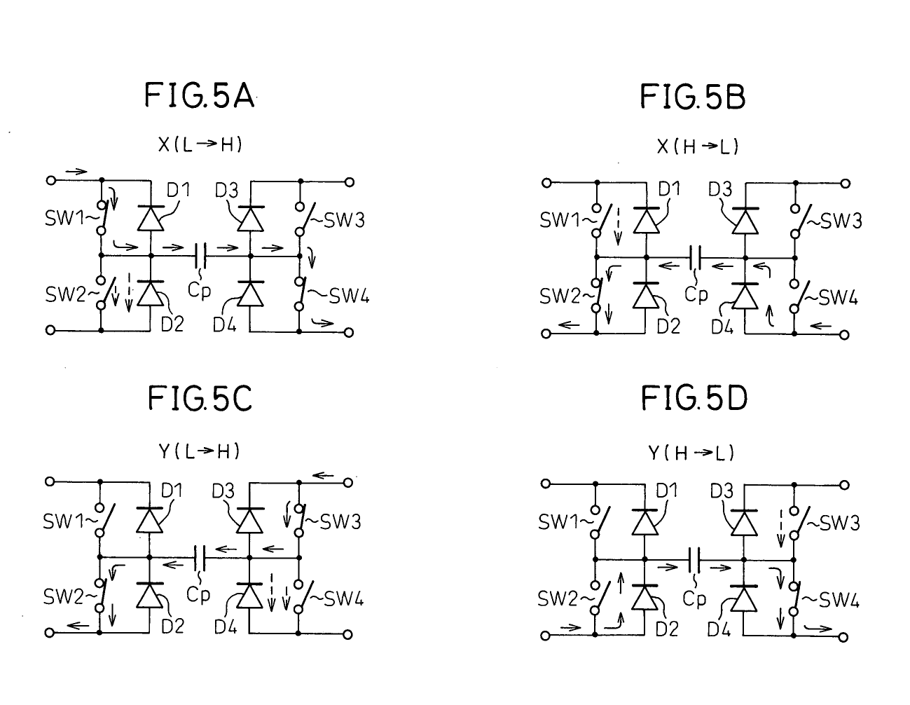

By the way, it is not necessary for SW4 to be in the ON-state continuously as shown in FIG. 9 but the SW4 can be put into the ON-state only during a period of time during which a current flows through D4 as shown by SW4′ in FIG. 10C. Moreover, as described in FIG. 5A to FIG. 5D, the residual carriers in D4 are formed when SW3 changes to the ON-state in order to change the Y electrode from L to H. Therefore, as shown by SW4″ in FIG. 10C, the timing with which SW4 changes to the ON-state in order to reduce the residual carriers in D4 can be arbitrary between t2 when SW2 changes to the ON-state and t3 when SW3 changes to the ON-state. The period of time during which SW4 is in the ON-state can be very short because the purpose is to reduce the residual carriers. Moreover, as shown by SW4′″ in FIG. 10C, it is possible to extend the period of time during which SW4 is in the ON-state until when after a current flowing through D4 is terminated. However, it is necessary to change SW4 into the OFF-state without fail by the time when SW3 changes to the ON-state.

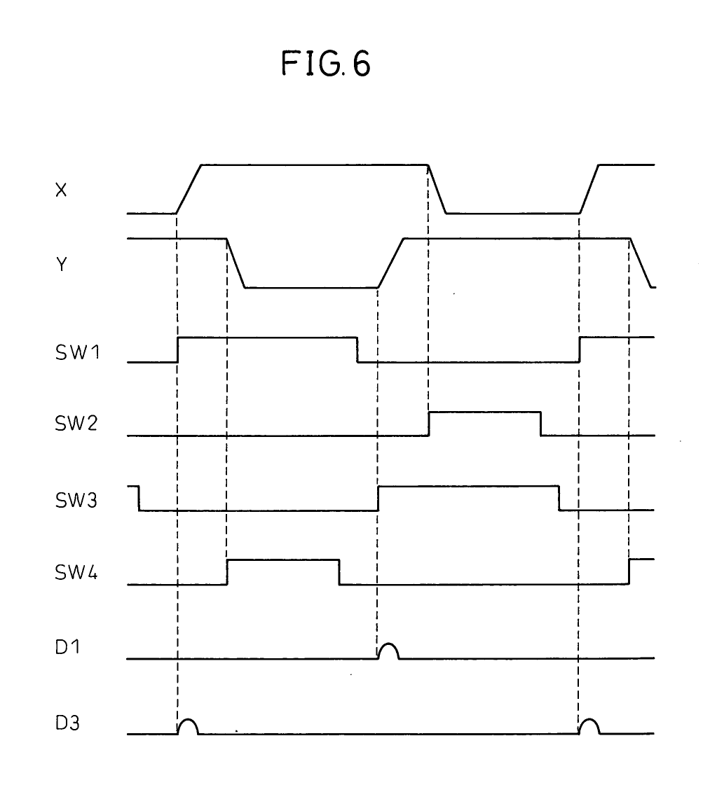

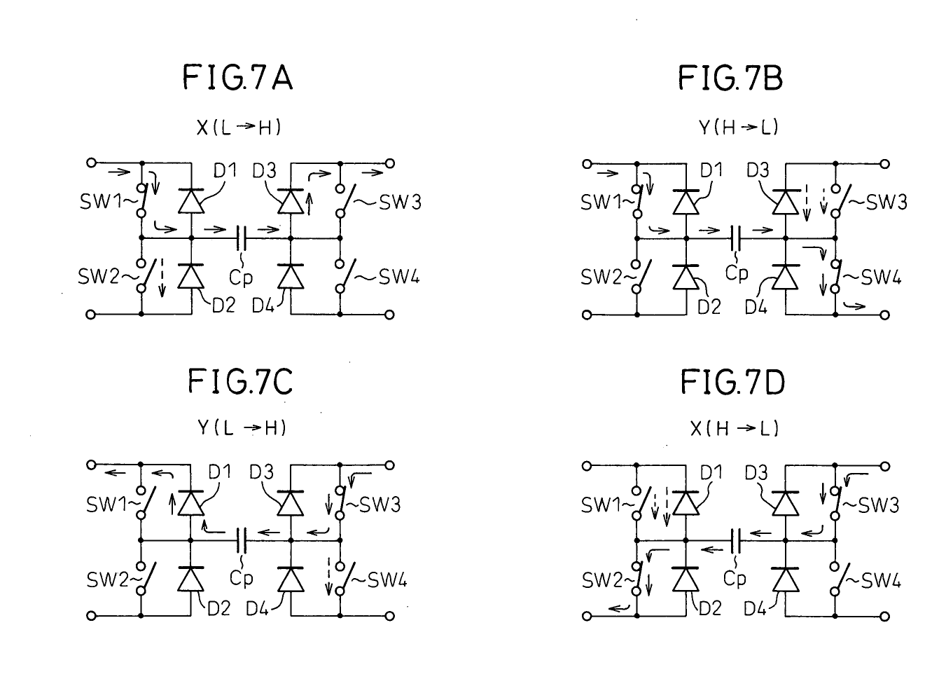

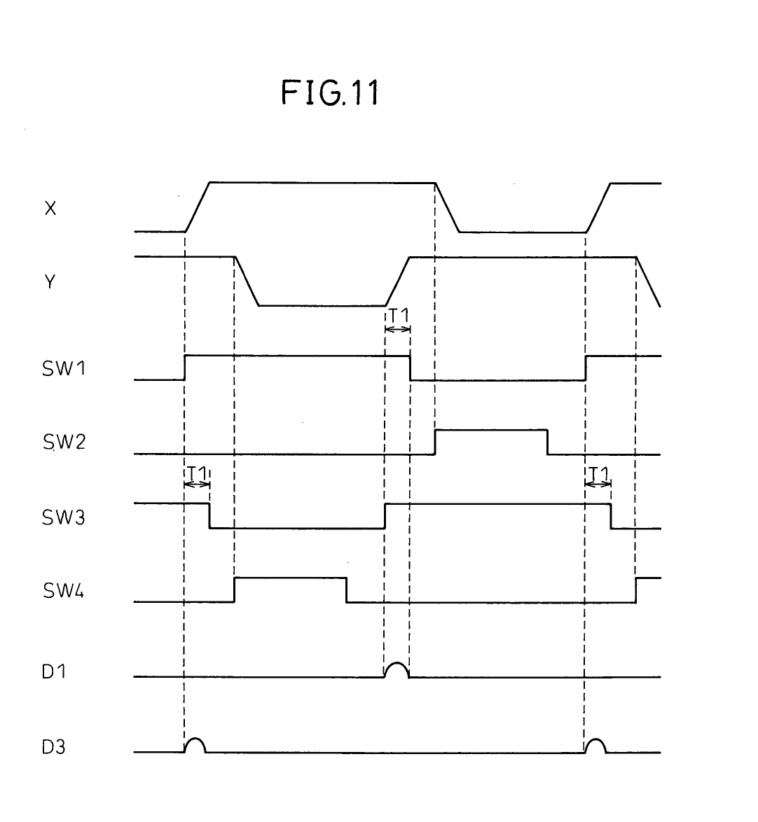

FIG. 11, which corresponds to FIG. 6, is a diagram showing switch timing of each switch circuit in the X electrode drive circuit 3 and the Y electrode drive circuit 4, changes in the potential of the X and Y electrodes, and currents flowing through the diodes D1 and D3 during the sustain period of a PDP apparatus in a second embodiment of the present invention. The PDP apparatus in the second embodiment has the same configuration as that of the PDP apparatus in the first embodiment. In the PDP apparatus in the first embodiment, there is a case where both potentials of the X electrode and Y electrode change to the low potential simultaneously but not a case where both potentials change to the high potential simultaneously during the sustain period. In the second embodiment, however, there is a case where both potentials of the X electrode and Y electrode changes to the high potential simultaneously, but not a case where both potentials change to the low potential simultaneously during the sustain period. As described in FIG. 6 and FIG. 7A to FIG. 7D, in this configuration, a current flows through D1 and D3 and residual carriers are formed. In the second embodiment, therefore, a period of time during which SW1 provided in parallel to D1 is in the ON-state is extended until when T1 elapses after SW3 is put into the ON-state state and a period of time during which SW3 provided in parallel to D3 is in the ON-state is extended until when T1 elapses after SW1 is put into the ON-state. The operation principles are the same as those in the first embodiment and modifications similar to those in the first embodiment can be performed. A detailed explanation will not be given here.

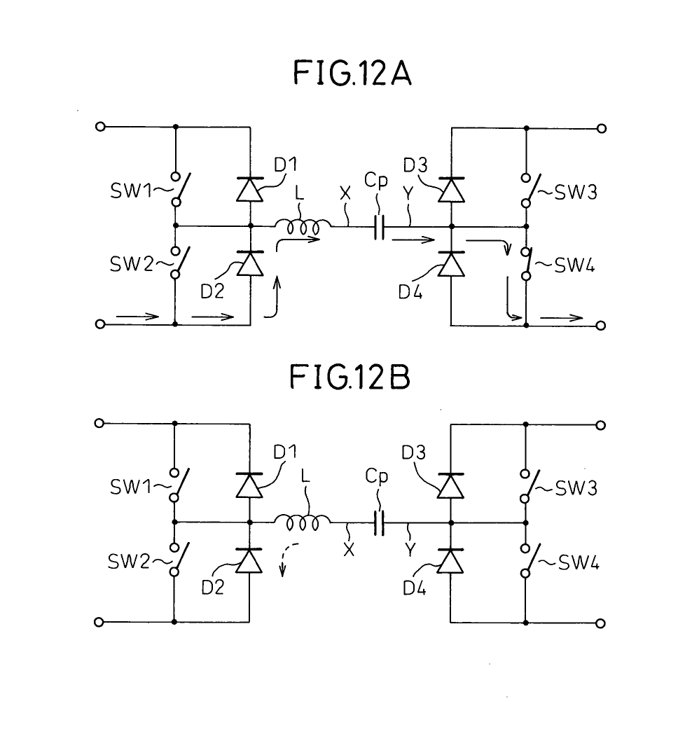

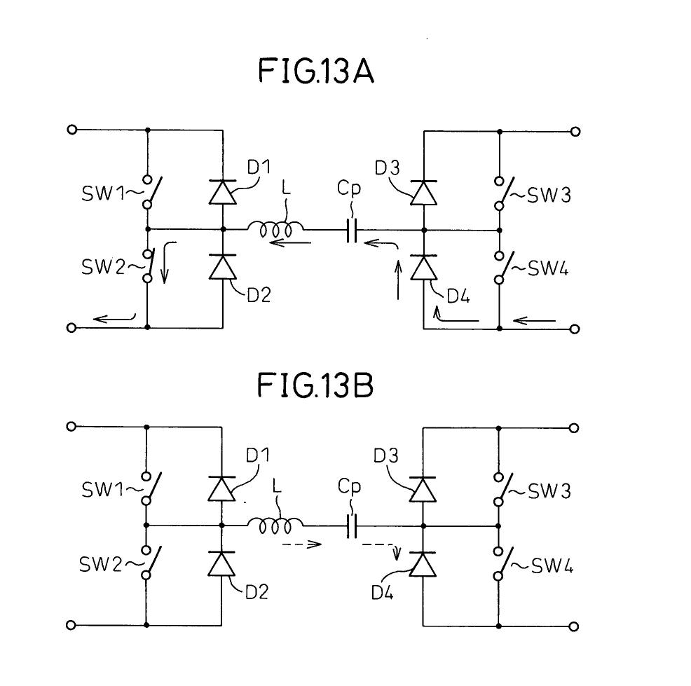

FIG. 12A and FIG. 12B are diagrams showing a configuration of the X electrode drive circuit and the Y electrode drive circuit in a PDP apparatus in a third embodiment of the present invention. Other configurations in the PDP apparatus in the third embodiment are the same as those in the PDP apparatus in the first embodiment. In the third embodiment, as shown in FIG. 12A and FIG. 12B, an inductance element L is provided at the output part to be connected to the X electrode of the X electrode drive circuit in the conventional example of the drive circuit shown in FIG. 2.

During the sustain period, if SW4 is put into the ON-state (the conduction state) after SW1 to SW3 are put into the OFF-state (the cutoff state) in order to change the potential of the Y electrode from H to L, a current path from the low potential power supply in the X electrode drive circuit to the low potential power supply in the Y electrode drive circuit via D2, the inductance element L, Cp, and SW4 is formed as shown in FIG. 12A. When the potential of the Y electrode changes to L and the current is terminated, a voltage VA in the opposite direction is generated due to the counter electromotive force of the inductance element L as shown in FIG. 12B. At this time, residual carriers are formed in D2 but are reduced due to the voltage VA in the opposite direction.

The inductance value of the inductance element L needs to be specified so that the minimum voltage VA that can reduce the residual carriers formed in the diode, the current flowing through the induction element L during discharge being taken into consideration.

The residual carriers in D4 in the Y electrode drive circuit can also be reduced by means of the inductance element L provided at the output part of the X electrode drive circuit. The operation principles are explained below with reference to FIG. 13A and FIG. 13B. During the sustain period, if SW2 is put into the ON-state (the conduction state) after SW1, SW3, and SW4 are put into the OFF-state (the cutoff state) in order to change the potential of the X electrode from H to L, a current path from the low potential power supply in the Y electrode drive circuit to the low potential power supply in the X electrode drive circuit via D4, Cp, the inductance element L, and SW2 is formed as shown in FIG. 13A. When the potential of the X electrode changes to L and the current is terminated, a voltage in the opposite direction is generated due to the counter electromotive force of the inductance element L as shown in FIG. 13B. The voltage is applied to D4 in the Y electrode drive circuit via Cp and reduces the residual carriers.

Although the inductance element L is provided at the output part of the X electrode drive circuit in the third embodiment, it is also possible to provide an inductance element at the output part of the Y electrode drive circuit.

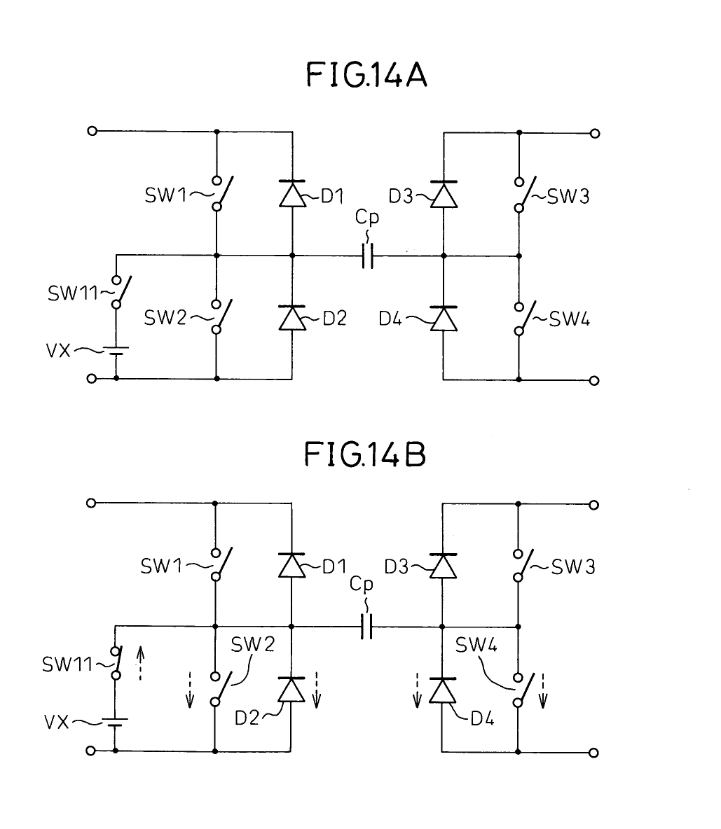

FIG. 14A and FIG. 14B are diagrams showing a configuration of the X electrode drive circuit and the Y electrode drive circuit in a PDP apparatus in a fourth embodiment of the present invention. Other configurations in the PDP apparatus in the fourth embodiment are the same as those in the PDP apparatus in the first embodiment. In the fourth embodiment, as shown in FIG. 14A and FIG. 14B, a voltage source VX that generates a potential higher than the low potential by Vx and lower than the high potential and an intermediate offset switch SW11 that switches connections between the terminal of the capacitive load and the voltage source are provided in the conventional drive circuit shown in FIG. 2A.

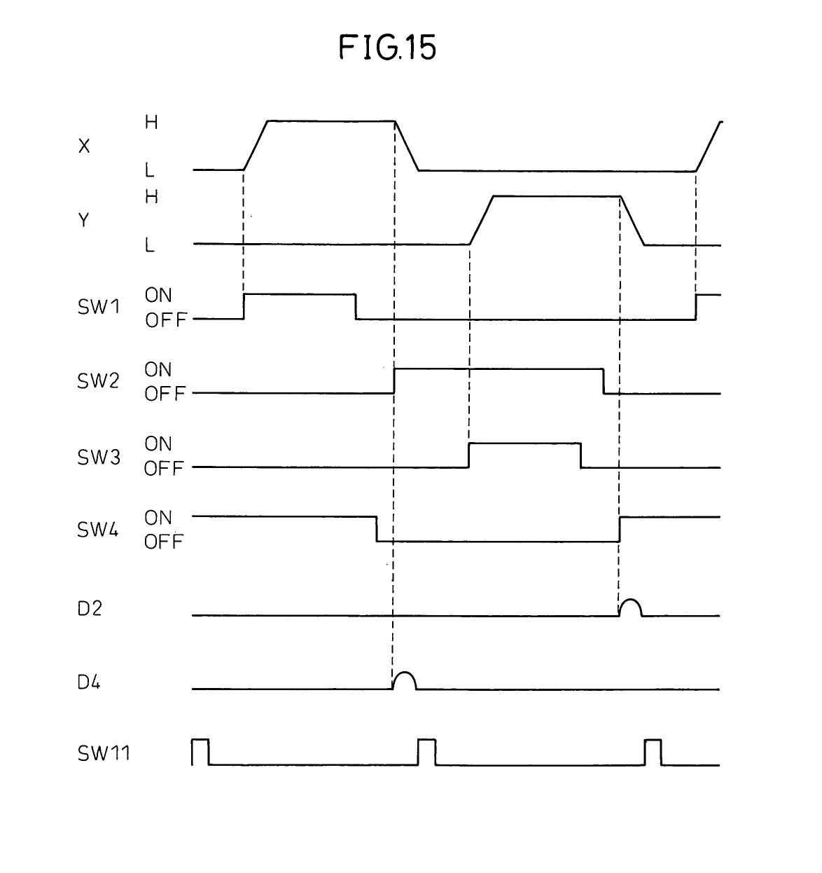

FIG. 15 is a diagram showing switch timing of each switch circuit in the X electrode drive circuit 3 and the Y electrode drive circuit 4, changes in the potential of the X and Y electrodes, and currents flowing through the diodes D2 and D4 during the sustain period of the PDP apparatus in the fourth embodiment. In the PDP apparatus in the fourth embodiment, there is a case where both potentials of the X electrode and Y electrode change to the low potential simultaneously, but not a case where both potentials change to the high potential simultaneously during the sustain period.

As shown in FIG. 5A to FIG. 5D, after the potential of the Y electrode changes from H to L, residual carriers are formed in D2 and SW2 and if SW1 is put into the ON-state in order to change the potential of the X electrode from L to H, the residual carriers in D2 and SW2 increase power consumption. Therefore, as shown in FIG. 15, if SW11 is put into the ON-state (the conduction state) during a period of time from when the potential of the Y electrode changes from H to L until when the potential of the X electrode changes from L to H, a closed circuit (a loop) composed of the voltage source VX, SW11, and SW2 or D2 is formed, the potential of the X electrode is raised to a potential higher than the low potential by Vx, and the residual carriers in D2 and SW2 are reduced.

After the potential of the X electrode changes from H to L, the residual carriers are formed in D4 and SW4, but if SW11 is put into the ON-state (the conduction state) during a period of time from when the potential of the X electrode changes from H to L until when the potential of the Y electrode changes from L to H, a closed circuit (a loop) composed of the voltage source VX, SW11, Cp, and SW4 or D4 is formed, the potential of the X electrode is raised to a potential higher than the low potential by Vx, and the residual carriers in D2 and SW2 are reduced via Cp.

The voltage Vx of the voltage source VX is sufficient as long as it is capable of reducing the residual carriers and it can be very small. For example, when the drive voltage is 180 V and Vx is 5 V, the power consumption by the residual carriers can be reduced to 1/36.

By the way, if SW11 is put into the ON-state, the potential of the X electrode increases from the low potential by Vx, but if the amount of increase is small, no problem will be brought about.

In the PDP apparatus in the fourth embodiment, there is a case where both potentials of the X electrode and Y electrode change to the low potential simultaneously but not a case where both potentials change to the high potential simultaneously during the sustain period, but in the configuration in the fourth embodiment, there is a case where both potentials of the X electrode and Y electrode change to the high potential simultaneously as in the second embodiment and the configuration can also be applied to a case where both potentials do not change to the low potential simultaneously. However, as when the X electrode is at the low potential, the Y electrode is at the high potential, therefore, the residual carriers in SW4 and D4 in the Y electrode drive circuit cannot be reduced. Therefore, it is necessary to provide the voltage source VX and SW11 both in the X electrode drive circuit and in the Y electrode drive circuit.

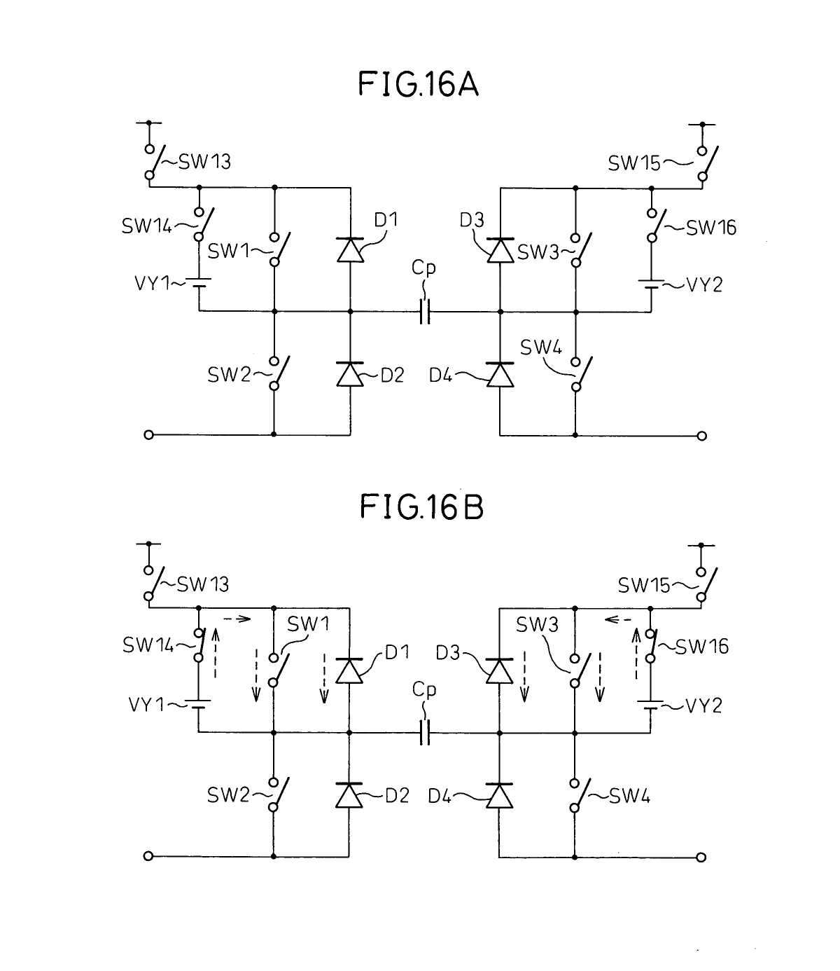

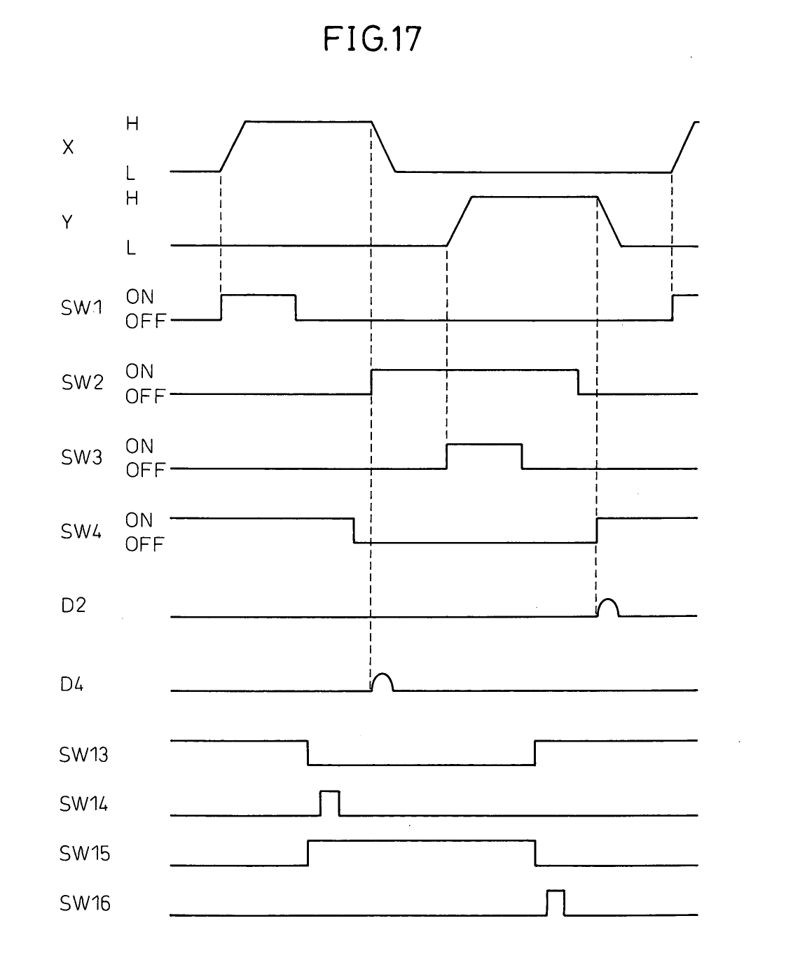

FIG. 16A and FIG. 16B are diagrams showing a configuration of the X electrode drive circuit and the Y electrode drive circuit in a PDP apparatus in a fifth embodiment of the present invention. Other configurations in the PDP apparatus in the fifth embodiment are the same as those in the PDP apparatus in the first embodiment. In the fifth embodiment, as shown in FIG. 16A and FIG. 16B, a switch SW13 that switches connections between the high-potential side terminal of the first switch circuit SW1 and the high-potential side power supply, a voltage source VY1 that generates a potential higher than the potential of the X electrode by a predetermined voltage Vy, and a high-potential offset switch SW14 that switches connections between the high-potential side terminal in the first switch circuit SW1 and the voltage source VY1 are provided in the conventional drive circuit shown in FIG. 2A. Similarly, a high-potential switch SW15 that switches connections between the high-potential side terminal in the third switch circuit SW3 and the high-potential side power supply, a voltage source VY2 that generates a potential higher than the potential of the Y electrode by a predetermined voltage Vy, and a high-potential offset switch SW16 that switches connections between the high-potential side terminal in the first switch circuit SW3 and the voltage source VY2 are provided.

FIG. 17 is a diagram showing switch timing of each switch circuit in the X electrode drive circuit 3 and the Y electrode drive circuit 4, changes in the potential of the X and Y electrodes, and currents flowing through the diodes D2 and D4 during the sustain period of the PDP apparatus in the fifth embodiment. FIG. 17 shows an example of a case where the potentials of the X electrode and of the Y electrode change to the low potential simultaneously but do not change to the high potential simultaneously.

As described in FIG. 5A to FIG. 5D, after the potential of the X electrode changes from L to H, residual carriers are formed in SW1 and if SW2 is put into the ON-state in order to change the potential of the X electrode from H to L, the residual carriers in SW1 increase the power consumption. Therefore, as shown in FIG. 17, SW13 is put into the OFF-state and SW14 is put into the ON-state during a period of time from when the potential of the X electrode changes from L to H until when the potential of the X electrode changes from H to L. Due to this, a closed circuit (a loop) composed of the voltage source VY1, SW14, and SW1 is formed. At this time, as the potential of the X electrode is at the high potential, the potential of the terminal of SW14 is higher than the high potential and the residual carriers in SW1 are reduced.

Similarly, after the potential of the Y electrode changes from L to H, residual carriers are formed in SW3 and, therefore, SW15 is put into the OFF-state and SW16 is put into the ON-state during a period of time from when the potential of the Y electrode changes from L to H until when the potential of the Y electrode changes from H to L, as shown in FIG. 17. Due to this, a closed circuit (a loop) composed of the voltage source VY2, SW16, and SW3 is formed. At this time, as the potential of the Y electrode is at the high potential, the potential of the terminal of SW16 is higher than the high potential and the residual carriers in SW3 are reduced.

By the way, as in the second embodiment, in the case where both potentials of the X electrode and Y electrode change to the high potential simultaneously but do not change to the low potential simultaneously, the residual carriers are formed in D1 and D3, as described in FIG. 7A to FIG. 7D. As shown in FIG. 16B, by putting SW13 into the OFF-state and SW14 into the ON-state, the residual carriers in SW1 and D1 can be reduced and by putting SW15 into the OFF-state and SW16 into the ON-state, the residual carriers in SW3 and D3 can be reduced.

The voltage Vy of the voltage sources VY1 and VY2 is sufficient as long as it is capable of reducing the residual carriers and can be very small. For example, when the drive voltage is 180 V and Vy is 5 V, the power consumption by the residual carriers can be reduced to 1/36.

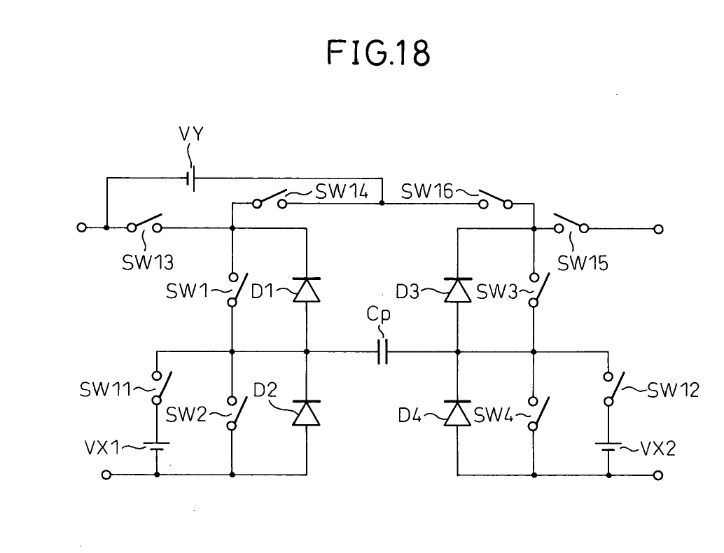

FIG. 18 is a diagram showing a configuration of a modification example, in which the fourth embodiment and the fifth embodiment are combined together. As shown schematically, the configuration of the modification example is characterized in that VX1 and VX2, which correspond to the voltage source VX in the fourth embodiment, and SW11 and SW12, which correspond to the intermediate offset switch SW11 in the fourth embodiment, are provided both in the X electrode drive circuit and in the Y electrode drive circuit, and VY1 and VY2 in the fifth embodiment are integrated into a power supply VY that generates a potential higher than the high-potential power supply by Vy. The operation principles of the modification example are a combination of the operation principles in the fourth embodiment and those in the fifth embodiment, and the operation principles can be applied to the case where both potentials of the X electrode and Y electrode change to the high potential simultaneously but do not change to the low potential simultaneously as in the second embodiment as well as the case where both potentials of the X electrode and Y electrode change to low potential simultaneously but do not change to the high potential simultaneously as in the fourth and fifth embodiments.

By the way, when the switches in the X electrode drive circuit are composed of MOSFETs, the switches in the Y electrode drive circuit are composed of IGBTs, and potentials are changed so that there is a case where both potentials of the X electrode and Y electrode change to the low potential simultaneously but do not change to the high potential simultaneously, the residual carriers in SW1 are few and D1 is not used during the sustain period, therefore, SW13 and SW14 need not be provided.

Next, the PDP apparatus in the fifth embodiment is explained. The PDP apparatus in the fifth embodiment is the ALIS system PDP apparatus described in U.S. Pat. No. 6,373,452. As the ALIS sytem PDP apparatus is described in detail in, for example, U.S. Pat. No. 6,373,452, a detailed explanation will not be given here but only the parts concerned will be explained below.

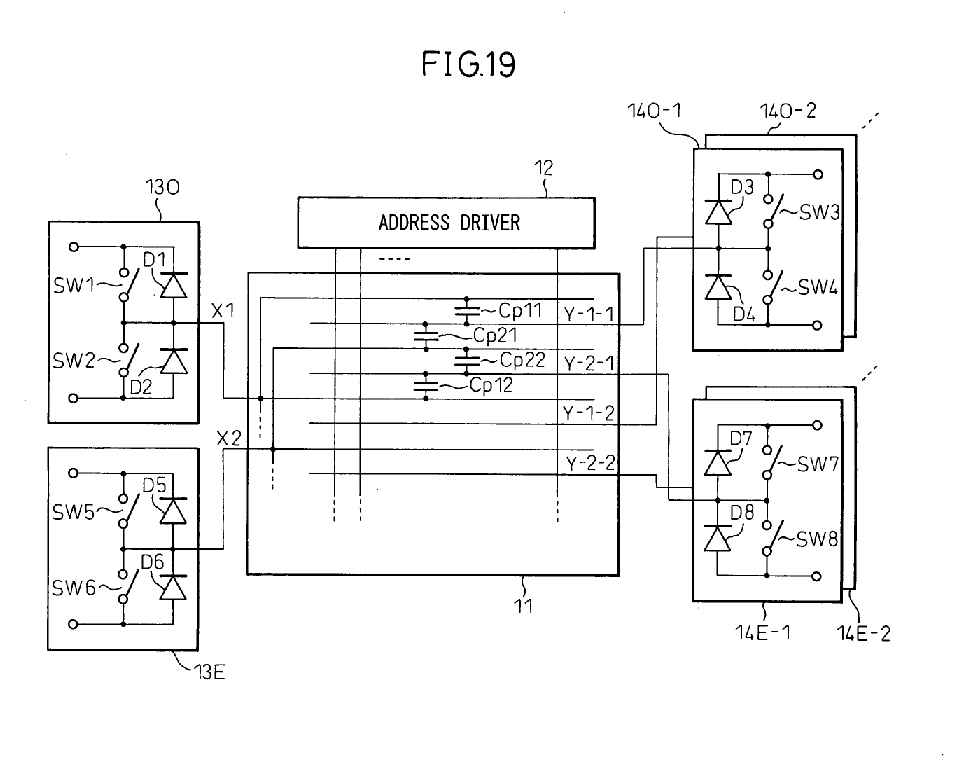

FIG. 19 is a diagram showing a general configuration of the ALIS system PDP apparatus in the fifth embodiment. As shown schematically, the PDP apparatus comprises a plasma display panel 11, an address driver 12, an odd X electrode drive circuit 130, an even X electrode drive circuit 13E, an odd Y electrode drive circuit, and an even Y electrode drive circuit. The odd Y electrode drive circuit is composed of individual odd Y electrode drive circuits 140-1, 140-2, . . . , the number of which is half that of the Y electrodes, and the individual odd Y electrode drive circuits each drive the respective corresponding odd-numbered Y electrodes. The even Y electrode drive circuit is composed of individual even Y electrode drive circuits 14E-1, 14E-2, . . . , the number of which is half that of the Y electrodes, and the individual even Y electrode drive circuits each drive the respective corresponding even-numbered Y electrodes. Hereinafter, the individual odd Y electrode drive circuits are shown together as an odd Y electrode drive circuit and the individual even Y electrode drive circuits are shown together as an even Y electrode drive circuit, as in the first embodiment.

In the plasma display panel 11, the X electrodes and the Y electrodes are arranged by turns at substantially equal intervals, therefore, capacitive loads are formed between each X electrode and the Y electrode adjacent to one side of the X electrode in question and between the X electrode and the Y electrode adjacent to the other side of the X electrode, and capacitive loads are formed between each Y electrode and the X electrode adjacent to one side of the Y electrode in question and between the Y electrode and the X electrode adjacent to the other side of the Y electrode. Here, a capacitive load formed between an odd-numbered X electrode and an odd-numbered Y electrode is denoted by Cp11, a capacitive load formed between an odd-numbered X electrode and an even-numbered Y electrode is denoted by Cp12, a capacitive load formed between an even-numbered X electrode and an odd-numbered Y electrode is denoted by Cp21, and a capacitive load formed between an even-numbered X electrode and an even-numbered Y electrode is denoted by Cp22. Moreover, an odd-numbered X electrode is denoted by X1, an even-numbered X electrode is denoted by X2, an odd-numbered Y electrode is denoted by Y1, and an even-numbered Y electrode is denoted by Y2.

Still moreover, a first display line is formed between each Y electrode and the X electrode adjacent to one side of the Y electrode in question and a second display line is formed between the Y electrode and the X electrode adjacent to the other side of the Y electrode. For example, the first display line is formed between the X1 electrode and the Y1 electrode and between the X2 electrode and the Y2 electrode, and the second display line is displayed between the Y1 electrode and the X2 electrode and between the Y2 electrode and X1 electrode. In the ALIS system PDP apparatus, an interlaced display is produced and the first display line is displayed in the odd field and the second display line is displayed in the even field. When the first display line is displayed (in the odd field), in-phase sustain pulses are applied to the X1 electrode and Y1 electrode and in-phase sustain pulses are applied to the X2 electrode and Y1 electrode during the sustain period. When the second display line is displayed (in the even field), in-phase sustain pulses are applied to the X1 electrode and Y1 electrode and in-phase sustain pulses are applied to the X2 electrode and the Y2 electrode during the sustain period.

In a PDP apparatus in a sixth embodiment also, switches SW1 and SW2 in the odd X electrode drive circuit 130 and switches SW5 and SW6 in the even X electrode drive circuit 13E are composed of MOSFETs and switches SW3 and SW4 in the plurality of the individual odd Y electrode drive circuits 140-1, 140-2, . . . , and switches SW7 and SW8 in the plurality of the individual even Y electrode drive circuits 14E-1, 14E-2, . . . , are composes of IGBTs. The individual odd Y electrode drive circuits 140-1, 140-2, . . . , and the individual even Y electrode drive circuits 14E-1, 14E-2, . . . , are integrated into IC chips, respectively. Individual diodes are used as diodes D1 to D8.

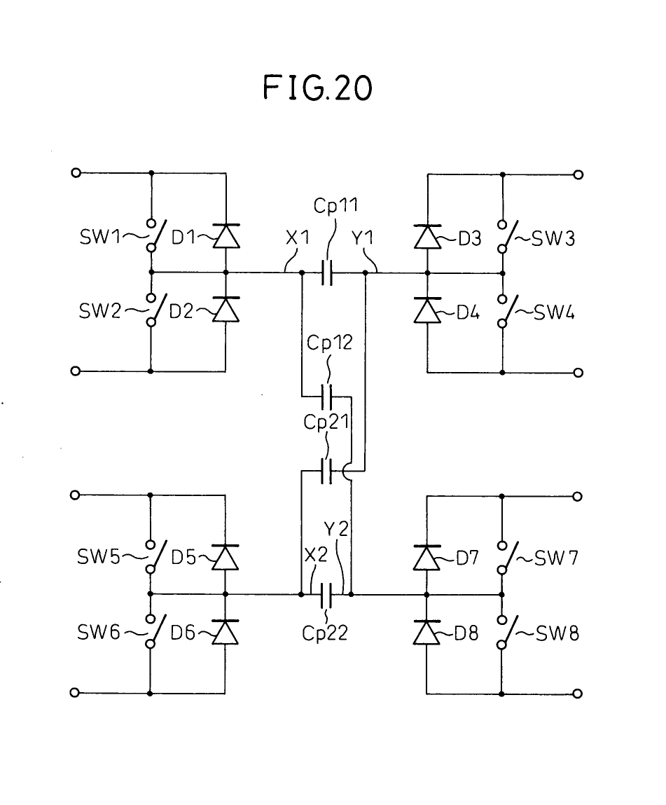

FIG. 20 is a diagram showing the configuration of the odd X electrode drive circuit 130, the even X electrode drive circuit 13E, the odd Y electrode drive circuit, and the even Y electrode drive circuit in the sixth embodiment. As shown schematically, the capacitive load Cp11 exists between the X1 electrode and the Y1 electrode, the capacitive load Cp12 exists between the X1 electrode and the Y2 electrode, the capacitive load Cp21 exists between the X2 electrode and the Y1 electrode, and the capacitive load Cp22 exists between the X2 electrode and the Y2 electrode. Other configurations are the same as those in the first embodiment.

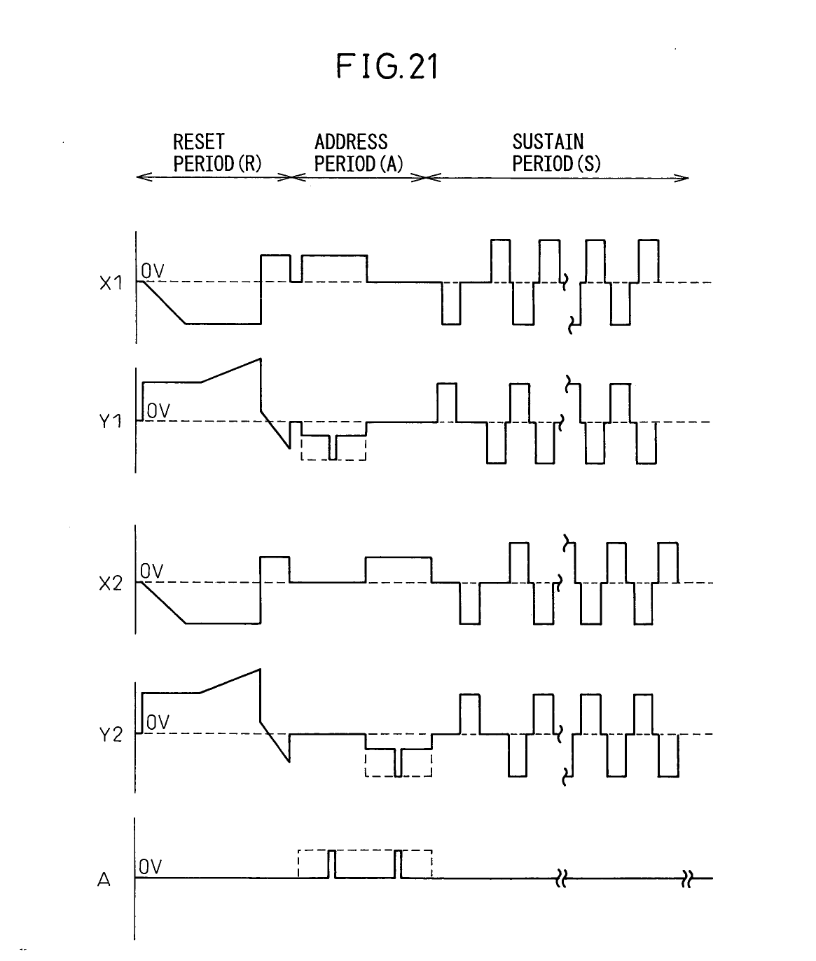

FIG. 21 is a diagram showing the drive waveforms in the odd field in the sixth embodiment. During the sustain period, in-phase sustain pulses are applied to the X1 electrode and Y2 electrode and in-phase sustain pulses are applied to the X2 electrode and Y1 electrode. A detailed explanation will not be given here.

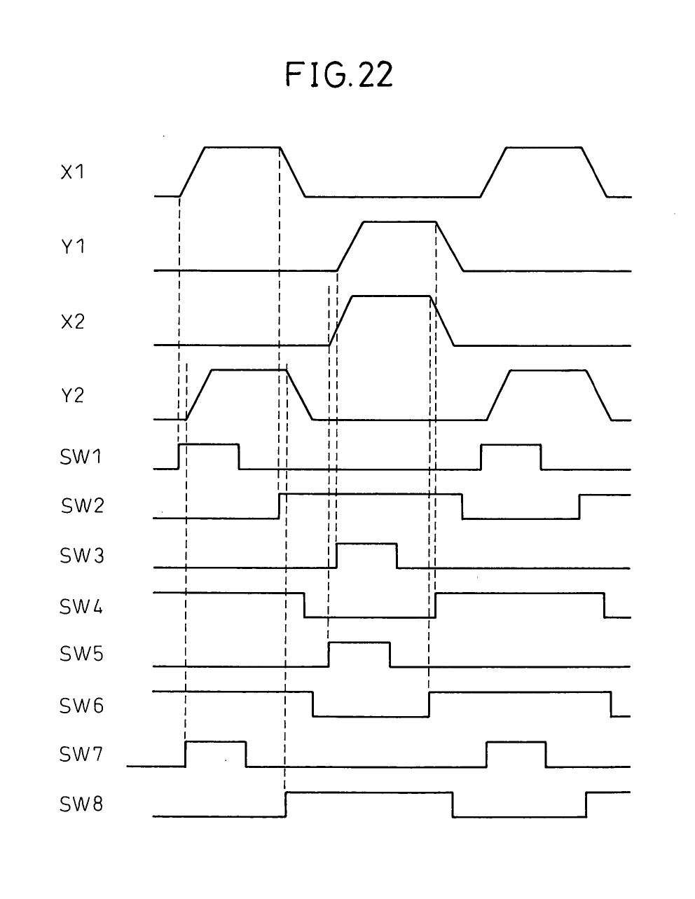

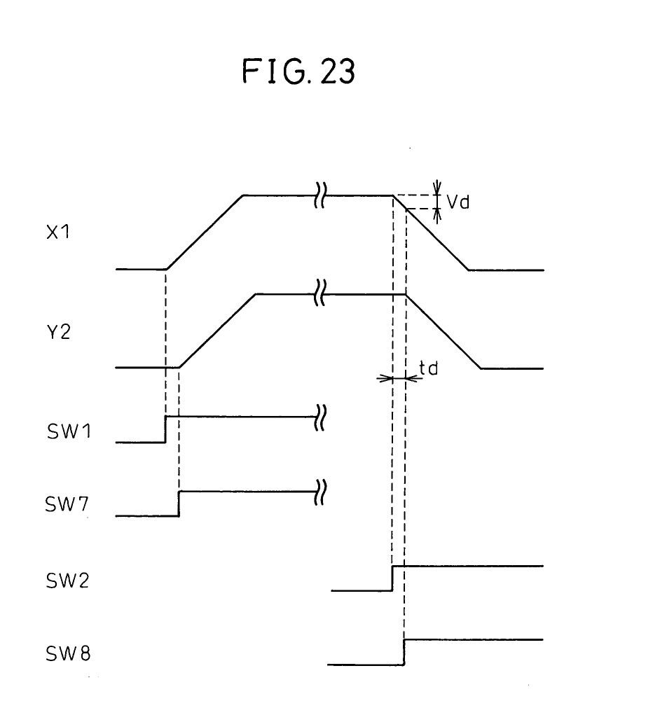

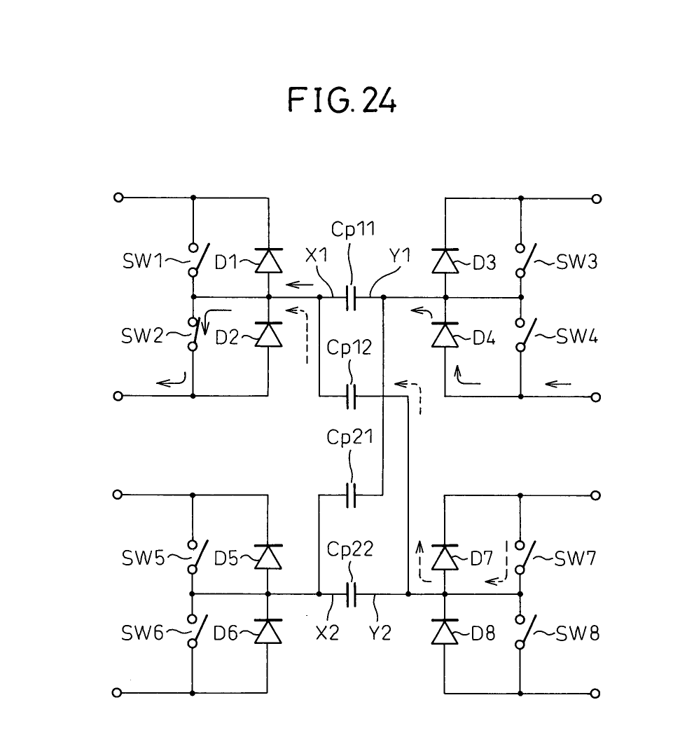

FIG. 22 is a diagram showing switch timing of each switch circuit, changes in the potential of the X1 electrode, the Y1 electrode, the X2 electrode, and the Y2 electrode, FIG. 23 is an enlarged diagram showing a part, and FIG. 24 is a diagram for explaining current paths in the sixth embodiment.

During the sustain period in the odd field in the conventional case, the potentials of the X1 electrode and Y2 electrode and the potentials of the X2 electrode and Y1 electrode change in phase but, during the sustain period in the odd field in the sixth embodiment, as shown in FIG. 22, the potential of the Y2 electrode changes slightly after the potential of the X2 electrode changes and the potential of the Y1 electrode changes slightly after the potential of the X2 electrode changes. In order to realize this situation, SW7 is put into the ON-state slightly after SW1, SW8 is put into the ON-state slightly after SW2, SW3 is put into the ON-state after SW5, and SW4 is put into the ON-state slightly after SW6. Here, the wording “slightly after” means a delayed time sufficiently shorter than a time required for the potential to change when the potential of the X electrode or Y electrode is changed by switching switches. When the switch is put into the ON-state, the potential of the X electrode or Y electrode changes according to a time constant determined based on the relationship between the capacitance of capacitive load and the amount of current, as shown in FIG. 22 and FIG. 23.

For example, when SW1 and SW7 are put into the ON-state and the X1 electrode and the Y2 electrode change to the high potential, as shown in FIG. 23, the Y1 electrode and the X2 electrode stay at the low potential. When SW1 and SW7 change into the OFF-state, residual carriers are formed in SW7. As SW1 is composed of a MOSFET, the amount of the residual carriers is small and therefore ignored.

Next, SW2 and SW8 change into the ON-state in order to change the X1 electrode and the Y2 electrode to the low potential. At this time, if SW2 and SW8 are put into the ON-state simultaneously as in the conventional case, the residual carriers in SW7 flow through SW8, resulting in large power consumption. In the sixth embodiment, on the contrary, SW2 is put into the ON-state earlier, therefore, a current path is formed from the high-potential power supply in the Y2 electrode drive circuit to the low-potential power supply in the X1 electrode drive circuit via SW7, Cp12, and SW2 and, therefore, the residual carriers in SW7 are reduced. When a time of td elapses after SW2 is put into the ON-state, SW8 is put into the ON-state, and if the potential of the X1 electrode drops from the high potential by Vd and the voltage difference Vd is maintained during the change of the X1 electrode and Y2 electrode, the residual carriers in SW7 are driven by the voltage difference Vd and reduced as a result. Therefore, for example, when the drive voltage is 180 V and the voltage difference is 5 V, the power consumption by the residual carriers in SW7 is reduced to 1/36.

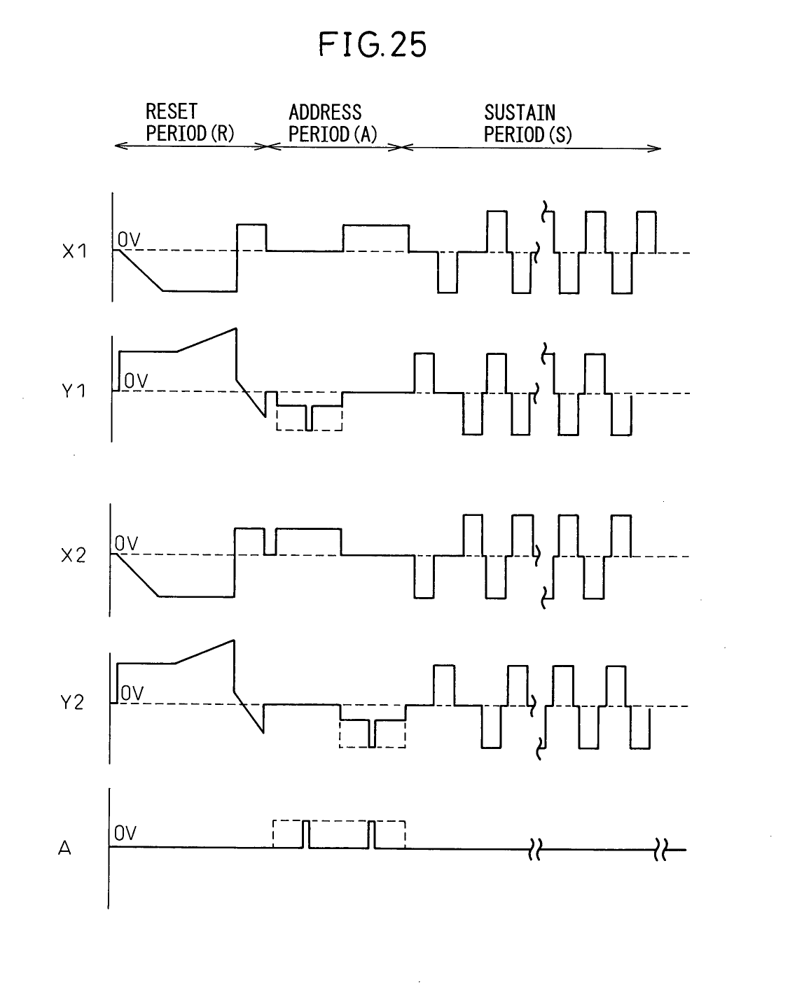

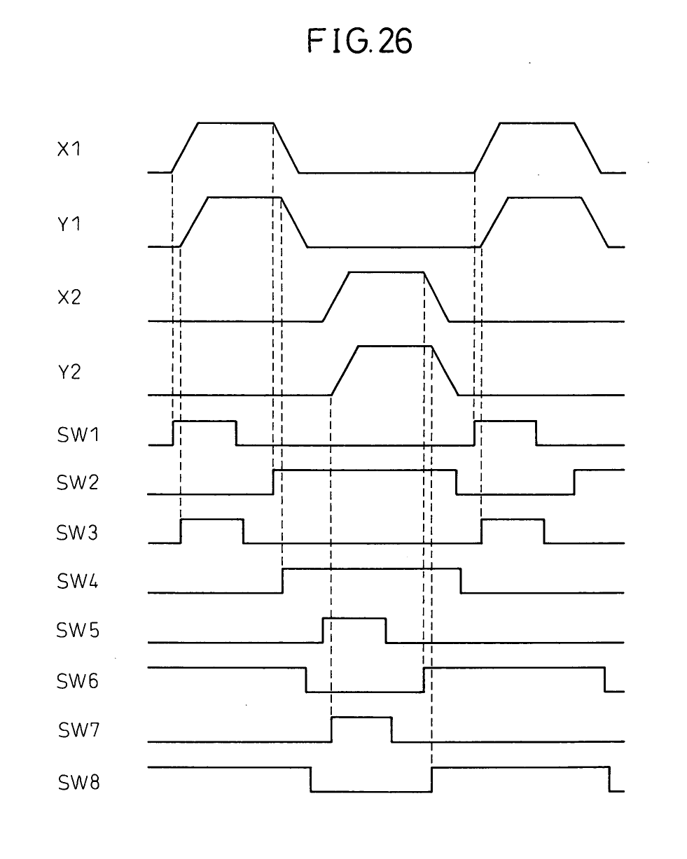

FIG. 25 shows drive the waveforms in the even field in the sixth embodiment and FIG. 26 shows switch timing in each switch circuit and changes in the potential of the X1 electrode, Y1 electrode, X2 electrode, and Y2 electrode during the sustain period in the even field in the sixth embodiment. As in the odd field, the change in the potential of the Y electrode in phase is delayed from the change in the potential of the X electrode. An explanation will not be given here.

Although the case where SW8 is put into the ON-state after SW2 is put into the ON-state is explained above, this applies to other cases and the power consumption by the residual carriers in IGBTs making up SW3, SW4, SW7 and SW8 can be reduced. By the way, SW1, SW2, SW5, and SW6 are composed of MOSFETs, therefore, the residual carriers are few and no problem will be brought about.

In the conventional ALIS system PDP apparatus, in-phase sustain pulses are applied to the X1 electrode and Y2 electrode, and the X2 electrode and Y1 electrode, respectively, therefore, Cp12 and Cp21 do not act as loads on the drive circuit but, in the sixth embodiment, Cp12 and Cp21 act as loads on the drive circuit because of the delay present between changes in potential. However, if the above-mentioned voltage difference Vd is small, the effect of the reduction in power consumption by the residual carriers is stronger than the effect of the increase in drive power due to Cp12 and Cp21.

Although the switches SW1, SW2, SW5, and SW6 in the odd and even X electrode drive circuits are composed of MOSFETs in the sixth embodiment, these switches can be composed of IGBTs. However, as the residual carriers in SW1, SW2, SW5, and SW6 cannot be reduced, the power consumption by these switches cannot be reduced. Nonetheless, the power consumption by the residual carriers in SW3, SW4, SW7, and SW8 in the odd and even X electrode drive circuits can be reduced, the effect can still be obtained.

The embodiments of the present invention are described as above and the configuration in each of the embodiments can be combined with the other configuration in the other embodiment, and how they are combined is determined appropriately based on the elements that make up the drive circuit and the drive waveforms.

As described above, according to the present invention, the power consumption by the residual carriers, which are formed when the elements such as diodes and IGBT that make up the capacitive load drive circuit are brought into conduction, can be reduced considerably, therefore, it is possible to reduce the heat that accompanies the power consumption as well as reducing the power consumption in the circuit. In the case of the integrated drive circuit, the heat produced in the integrated circuit brings about a big problem and the increase in drive frequency is limited, but according to the present invention, the drive frequency can be increased because the production of heat can be suppressed. In particular, the display luminance of a PDP apparatus can be further improved according to the present invention because the display luminance of a PDP apparatus is limited by the drive frequency (the sustain frequency).

Moreover, according to the present invention, the undesired power consumption by the residual carriers, which occupies a large part of the total power consumption, can be reduced by only changing the drive sequence or additionally providing a simple circuit, therefore, the power consumption can be reduced considerably while the increase in cost can be maintained at minimum.

Still further by applying the present invention to a PDP apparatus, the power consumption can be reduced, therefore, the production of heat in drive elements can be suppressed, the display luminance of the PDP apparatus can be increased, and a flat display apparatus capable of producing a much brighter display can be realized.

1. A method for driving a capacitive load drive circuit, the capacitive load drive circuit comprising:
a first switch circuit for switching connections between a terminal of a capacitive load and a high-potential side power supply;
a second switch circuit for switching connections between the terminal and a low-potential side power supply; and
a diode provided in parallel to the first switch circuit or the second switch circuit, in which the potential of the terminal of the capacitive load is changed between the high potential and the low potential,
wherein the method comprising a period of time during which the switch circuit connected in parallel to the diode is brought into conduction during a period of time from when the diode is brought into conduction until when the potential of the terminal to which the diode is connected changes.

2. A method for driving a capacitive load drive circuit, the capacitive load drive circuit comprising:
a first drive circuit for changing the potential of one of terminals of a capacitive load between the high potential and the low potential; and
a second drive circuit for changing the potential of the other terminal of the capacitive load between the high potential and the low potential, in which the respective first and second drive circuits comprise:
a first switch circuit for switching connections between a terminal to be connected and a high-potential side power supply;
a second switch circuit for switching connections between the terminal to be connected and a low-potential side power supply; and
a diode provided in parallel to the first switch circuit or the second switch circuit,
wherein the method comprising a period of time during which the switch circuit connected in parallel to the diode is brought into conduction during a period of time from when the diode is brought into conduction until when the potential of the terminal to which the diode is connected changes.

3. A plasma display apparatus comprising:
a plasma display panel having a plurality of first and second electrodes arranged adjacently and a plurality of address electrodes extending in the direction perpendicular to the direction in which the first and second electrodes extend, in which a sustain discharge is caused to occur between the first and second electrodes adjacent to each other;
a first electrode drive circuit for driving the plurality of the first electrodes; and
a second electrode drive circuit for driving the plurality of the second electrodes,
wherein the respective first and second electrode drive circuits comprise:
a first switch circuit for switching connections between an electrode to be connected and a high-potential side power supply;
a second switch circuit for switching connections between the electrode to be connected and a low-potential side power supply; and
a diode provided in parallel to the first switch circuit or the second switch circuit, and
wherein the plasma display apparatus comprises a period of time during which the switch circuit connected in parallel to the diode is brought into conduction during a period of time from when the diode is brought into conduction until when the potential of the electrode to which the diode is connected changes, during the sustain discharge.

4. A capacitive load drive circuit comprising:
a first switch circuit for switching connections between a terminal of a capacitive load and a high-potential side power supply;
a second switch circuit for switching connections between the terminal and a low-potential side power supply; and
a diode provided in parallel to the first switch circuit and the second switch circuit,
wherein an output part comprises an inductance element.

5. A capacitive load drive circuit comprising:
a first drive circuit for changing one of the terminals of a capacitive load between the high potential and the low potential; and
a second drive circuit for changing the other terminal of the capacitive load between the high potential and the low potential,
wherein the respective first and second drive circuits comprise:
a first switch circuit for switching connections between a terminal to be connected and a high-potential side power supply;
a second switch circuit for switching connections between the terminal to be connected and a low-potential side power supply; and
a diode provided in parallel to the first switch circuit or the second switch circuit, and
wherein an inductance element is provided at least one of parts between the first drive circuit and the one of the terminals and between the second drive circuit and the other terminal.

6. A capacitive load drive circuit comprising:
a first switch circuit for switching connections between a terminal of a capacitive load and a high-potential side power supply;
a second switch circuit for switching connections between the terminal and a low-potential side power supply; and
a diode provided in parallel to the first switch circuit or the second switch circuit,
wherein the capacitive load drive circuit further comprises:
a voltage source for generating a potential higher than the low potential and lower than the high potential; and
an intermediate offset switch for switching connections between the terminal and the voltage source.

7. The method for driving the capacitive load drive circuit set forth in claim 6,
wherein when the terminal is at the low potential, the intermediate offset switch is brought into conduction by temporarily putting into the ON-state.

8. A capacitive load drive circuit comprising:
a first drive circuit for changing one of the terminals of a capacitive load between the high potential and the low potential; and
a second drive circuit for changing the other terminal of the capacitive load between the high potential and the low potential;
wherein the respective first and second drive circuits comprise:
a first switch circuit for switching connections between a terminal to be connected and a high-potential side power supply;
a second switch circuit for switching connections between the terminal to be connected and a low-potential side power supply; and
a diode provided in parallel to the first switch circuit or the second switch circuit,
wherein at least one of the first and second drive circuits comprises:
a voltage source that generates a potential higher than the low potential and lower than the high potential; and
an intermediate offset switch for switching connections between the terminal to be connected and the voltage source.

9. The method for driving the capacitive load drive circuit set forth in claim 8, wherein when both the terminals of the capacitive load are at the low potential, the intermediate offset switch is brought into conduction by temporarily putting it into the ON-state.

10. A plasma display apparatus comprising:
a plasma display panel having a plurality of first and second electrodes arranged adjacently and a plurality of address electrodes extending in the direction perpendicular to the direction in which the first and second electrodes extend, in which a sustain discharge is caused to occur between the first and second electrodes adjacent to each other;
a first electrode drive circuit for driving the plurality of the first electrodes; and
a second electrode drive circuit for driving the plurality of the second electrodes,
wherein the respective first and second electrode drive circuits comprise:
a first switch circuit for switching connections between an electrode to be connected and a high-potential side power supply;
a second switch circuit for switching connections between the electrode to be connected and a low-potential side power supply; and
a diode provided in parallel to the first switch circuit or the second switch circuit,
wherein at least one of the first and second electrode drive circuits comprises:
a voltage source that generates a potential higher than the low potential and lower than the high potential; and
an intermediate offset switch for switching connections between the terminal to be connected and the voltage source, and
wherein a period of time is comprised, during which the intermediate offset switch is brought into conduction by temporarily putting into the ON-state when both the terminals of the capacitive load are at the low potential, during the sustain period.

11. A capacitive load drive circuit comprising:
a first switch circuit for switching connections between a terminal of a capacitive load and a high-potential side power supply;
a second switch circuit for switching connections between the terminal and a low-potential side power supply; and
a diode provided in parallel to the first switch circuit or the second switch circuit,
wherein the capacitive load drive circuit further comprises:
a high power supply switch for switching connections between the high-potential side terminal of the first switch circuit and the high-potential side power supply;
a voltage source for generating a potential higher than the high potential by a predetermined value; and
an intermediate offset switch for switching connections between the high-potential side terminal of the first switch circuit and the high-potential side power supply.

12. The method for driving the capacitive load drive circuit set forth in claim 11, wherein the high-potential offset switch is brought into conduction by temporarily putting it into the ON-state when the terminal is at the high potential.

13. A capacitive load drive circuit comprising:
a first drive circuit for changing the potential of one of the terminals of a capacitive load between the high potential and the low potential; and
a second drive circuit for changing the other terminal of the capacitive load between the high potential and the low potential,
wherein the respective first and second drive circuits comprise:
a first switch circuit for switching connections between a terminal to be connected and a high-potential side power supply;
a second switch circuit for switching connections between the terminal to be connected and a low-potential side power supply; and
a diode provided in parallel to the first switch circuit and the second switch circuit, and
wherein at least one of the first and second drive circuits comprises:
a high power supply for switching connections between the high-potential side terminal of the first switch circuit and the high-potential side power supply;
a voltage source for generating a potential higher than the high potential by a predetermined value; and
a high-potential offset switch for switching connections between the high-potential side terminal of the first switch circuit and the voltage source.

14. The method for driving the capacitive load drive circuit set forth in claim 13, wherein the high-potential side offset switch brought into conduction by temporarily putting into the ON-state when the terminal to be driven by the drive circuit equipped with the high-potential offset switch is at the high potential.

15. A plasma display apparatus comprising:
a plasma display panel having a plurality of first and second electrodes arranged adjacently and a plurality of address electrodes extending in the direction perpendicular to the direction in which the first and second electrodes extend, in which a sustain discharge is caused to occur between the first and second electrodes adjacent to each other;
a first electrode drive circuit for driving the plurality of the first electrodes; and
a second electrode drive circuit for driving the plurality of the second electrodes,
wherein the respective first and second electrodes drive circuits comprise:
a first switch circuit for switching connections between an electrode to be connected and a high-potential side power supply;
a second switch circuit for switching connections between the electrode to be connected and a low-potential side power supply; and
a diode provided in parallel to the first switch circuit or the second switch circuit,
wherein at least one of the first and second electrode drive circuit comprises:
a high power supply switch for switching connections between the high-potential side terminal of the first switch circuit and the high-potential side power supply;
a voltage source for generating a potential higher than the high potential by a predetermined value; and
a high-potential offset switch for switching connections between the high-potential side terminal of the first switch circuit and the voltage source, and
wherein the high-potential offset switch is brought into conduction by temporarily putting into the ON-state when the terminal to be driven by the drive circuit equipped with the high-potential offset switch is at the high potential, during the sustain period.

16. A plasma display apparatus comprising:
a plasma display panel having first electrodes and second electrodes arranged adjacently by turns and address electrodes extending in the direction perpendicular to the direction in which the first and second electrodes extend, in which a first display line is formed between one end of the second electrode and the first electrode adjacent to the one side of the second electrode and a second display line is formed between the other side of the second electrode and the first electrode adjacent to the other side of the second electrode,
an odd first electrode drive circuit for driving the odd-numbered first electrodes;
an even first electrode drive circuit for driving the even-numbered first electrodes;
an odd second electrode drive circuit for driving the odd-numbered second electrodes; and
an even second electrode drive circuit for driving the even-numbered second electrodes,
wherein the respective electrode drive circuits comprise:
a first switch circuit for switching connections between a terminal to be connected and a high-potential side power supply;
a second switch circuit for switching connections between the terminal to be connected and a low-potential side power supply; and
a diode provided in parallel to the first switch circuit or the second switch circuit,
wherein, during the sustain period in the odd field, the odd first electrode drive circuit and the even second electrode drive circuit, and the odd second electrode drive circuit and the even first electrode drive circuit supply in-phase sustain pulses respectively to produce a display in the first display line;
wherein during the sustain period in the even field, the odd first electrode drive circuit and the odd second electrode drive circuit, and the even first electrode drive circuit and the even second electrode drive circuit supply in-phase sustain pulses respectively to produce a display in the second display line,
wherein during the sustain period in the odd field, the even second electrode drive circuit supplies a sustain pulse that is slightly delayed from that supplied from the odd first electrode drive circuit, and the odd second electrode drive circuit supplies a sustain pulse slightly delayed from that supplied from the even first electrode drive circuit, and
wherein during the sustain period in the even field, the odd second electrode drive circuit supplies a sustain pulse slightly delayed from that supplied from the odd first electrode drive circuit, and the even second electrode drive circuit supplies a sustain pulse slightly delayed from that supplied from the even first electrode drive circuit.

17. The plasma display apparatus as set forth in claim 16,
wherein the odd first electrode drive circuit drives the odd-numbered first electrodes commonly,
wherein the even first electrode drive circuit drives the even-numbered first electrodes commonly,
wherein the odd second electrode drive circuit applies a scan pulse sequentially to the odd-numbered second electrodes during the address period and drives the odd-numbered second electrodes commonly during the sustain period,
wherein the even second electrode drive circuit applies a scan pulse sequentially to the even-numbered second electrodes during the address period and drives the even-numbered second electrodes commonly during the sustain period,
wherein the odd and even second electrode drive circuits comprise a plurality of individual second electrode drive circuits for driving the odd-numbered and even-numbered second electrodes, respectively, and
wherein each of the individual second electrode drive circuits comprises the first switch circuit, the second switch circuit, and the diode, respectively.

18. The plasma display apparatus as set forth in claim 17, wherein the plurality of the individual second electrode drive circuits are integrated at least for the odd second electrode drive circuit and the even second electrode drive circuit, respectively.

19. The plasma display apparatus as set forth in claim 17, wherein the first switch circuit and the second switch circuit of the plurality of the individual second electrode drive circuits are composed of IGBTs.

20. The plasma display apparatus as set forth in claim 17, wherein the first switch circuit and the second switch circuit of the odd and even first electrode drive circuits are composed of MOSFETs.
